(19) United States
(12) Patent Application Publication
(10) Pub. No.: US 2007/0117071 A1
(43) Pub. Date: May 24, 2007

(54) Math 'N More

(76) Inventor: Jan S. Bedell, Plano, TX (US)

Correspondence Address: Jan Bedell, 3366 Lanarc Dr., Plano, TX, 75023, US

(21) Appl. No.: 11/238,902

(22) Filed: Sep. 30, 2005

(51) Int. Cl. G09B 19/00

(52) U.S. Cl. 434/236

(57) ABSTRACT

A curriculum series and method of providing extra-sensory stimulation for the purpose of serving basic educational needs, as well as stimulating and improving cognitive processing. Auditory stimulation can be activated via a teacher/student interaction and/or can include a cassette or CD player combined with an audio module to present drill and practice based on the Neurodevelopmental Approach, which is with frequency, intensity and controlled duration.

Math 'N More is an educational and therapeutic curriculum for people from ages two and up based on the Neurodevelopmental Approach which includes specific stimulation of visual, auditory, tactile, fine and gross motor, manual and language areas of the brain. This curriculum is multi-sensory (visual, tactile, and auditory which utilizes physical activities, audio CD tutorials, data CDs and may incorporate computer CDs and DVDs) and has multiple educational goals in teaching counting, math, reading, writing, developing good visualization discrimination, conceptual thinking and cognitive processing. A special focus on increasing visual and auditory processing, as well as, establishing lower level brain organization is a crucial part of this curriculum. There are multiple levels involved which serve to incorporate developmental activities based on age, educational skills, developmental status and/or mental capability. This curriculum is utilized with individuals ranging from gifted to mentally challenged, including brain injured from age 2 to adult.

All levels of the curriculum are specifically designed to stimulate the brain in order to firmly establish neuro-pathways (represented by the subjects ability to receive, store, process and utilize information representing knowledge) to help the individual reach their full potential academically, enhance learning abilities, correct neurological inefficiencies, learning difficulties, eliminate neuro-blockages, or developmental issues related to educational concerns. The design of this curriculum works via sensory stimulation required by each of the educational components whether they be in print, audio or visual, multi-sensory computerized or taped media which work to construct synaptic connections to build basic structures that represent knowledge.

Math 'N More Educational & Therapeutic Series incorporates multiple levels and products in multiple media types based on stimulating cognitive processing, information processing and activating learning—

(1) Math N' More Level 1

(2) Math N' More Level 2

(3) Math N' More Level 3

(4) Math N' More Level 4

(5) Math N' More Level 5

(6) Math N' More Manipulatives

(7) Math N' More Flash Cards

(8) Math N' More Computer Programs

(9) Math N' More Auditory CDs

(10) Math N' More Counting

(11) Math N' More Reading

(12) Math N' More Writing

(13) Math N' More Math

(14) Math N' More Math Facts In A Flash

Any and all related products designed by Math N' More are not limited to the specific mentioned items above. No limitations are on the combinations, substitutions, or future developed products in the Math 'N More Series that will increase the ability of an individual to consciously receive incoming sensory information and to organize, classify, discriminate, store, process and utilize information.

Integrated throughout Math N' More Early Learning Series are the following concepts:

(1) 1 to 1 Correspondence

(2) Number Recognition (1−30+)

(3) Identifying Number Words (one to twenty)

(4) Pattern Recognition

(5) More and Less

(6) Rote Counting (1−50+)

(7) Identifying 11 Basic Shapes

(8) Number Tracing

(9) Auditory and Visual Processing

(10) Lower Level Brain Organization

(11) Story Problems

(12) Finger Dexterity

(13) Pre-writing and Reading Skills

(14) Visual Discrimination

(15) Higher Level Thinking Skills (Categories)

(16) Addition and Subtraction Finger Math

(17) Auditory Processing Activity CDs

(18) Input Activities Answer Sheets

(19) Speed Drills for Math Facts

(20) Flash Card Math Facts Activity for Permanent Rapid Recall Reinforcement.

PHILOSOPHY AND INTRODUCTION: The concept of Math N' More is unique in that it combines knowledge of how the brain learns with a step by step approach to teaching math and reading and writing readiness skills. It was developed with a combination of experts including ICAN Neurodevelopmentalists, special education teachers, home-schooling parents and real children. The end result is a math curriculum that can be utilized by a huge variety of children. This encompasses children from the very young preschooler who is begging to learn to a child with Down Syndrome who may need more time and repetition. The program is designed to move as quickly as possible or as slowly as needed to meet the needs of each individual child. It provides many pages of repetition for those who need it.

HOW LEARNING OCCURS: The brain is a mysterious and wonderful creation with great plasticity. Research has proven that additional specific stimulation of the brain in areas where a child or adult has had injury or insufficient neuro-stimulation as infants, can create a branching in the dendrites, and thus change the status of the neuro-pathways. With stronger neuro-pathways established, better connectivity between the brain and body are accomplished which increases the ability of the individual in areas a brain organization, auditory and visual processing, fine and gross motor skills, and language skills which will allow the individual to acquire information easier, retain and utilize it as knowledge. Understanding how a child learns best can enable parents and teachers to be more effective when presenting new information and educating their students. The first concept to understand is INPUT versus OUTPUT. It is a common misconception that when a child is outputting (giving you an answer orally, writing something down or performing a task) that they are being taught. The truth is that if a child can do these tasks he has already been taught and has learned. He is simply outputting what he has learned. Many times we expect output from him too soon. When a child lacks the ability to output answers or tasks, it is a cue to us that we need to make sure the information has been input enough for the child to retain and utilize it. With Math N' More, you will become aware that often the parent is inputting (telling or showing the child) information before asking for output. This is not cheating. This is what teaching is really about—giving the child information so that eventually he will be able to output it for you. With this in mind, be sure to read the directions for each activity carefully for best results.

Keys To Understanding How The Brain Receives There are three keys to understanding how the brain receives input for future output or utilization of what is taught. Those keys are: FREQUENCY, INTENSITY and DURATION. These keys are necessary and helpful in learning absolutely everything in life, but for this discussion it is vital that you remember these keys as you begin to teach your child math. Numerous studies have been conducted showing that the brain remembers and learns most efficiently when presented with information FREQUENTLY, with HIGH INTENSITY and having appropriate DURATION. This is especially important when learning math. Let's go over the meaning of these words.

FREQUENCY: This refers to how many times something occurs. Specifically, how many times or how often information is presented in a 24 hour period.

INTENSITY: This refers to how the information is presented. Some presentations may be boring to the brain, while others will challenge and stimulate the brain to pay closer attention.

DURATION: This refers to how long something lasts.—how many minutes, hours or days.

For your child to learn the skills to be successful in math the quickest and most efficient way possible, it is necessary for you to present the information with appropriate Frequency, Intensity and Duration. Your child will learn quicker if you present the information—or do the pages FREQUENTLY—maybe 2 to 4 times in a day. Frequency is included on each page of Math N' More as the same concept or task is presented in many and varied forms. The tasks are fun so you will be engaged with your child presenting the information with HIGH INTENSITY. The time you are working with your child needs to be positive—and to keep the intensity and interest up it needs to be quick and happy. It is far better to do 30 seconds of quick and positive input than two minutes of negative, boring input. If things get negative or boring, the child will turn off his brain. Nothing will be going in and no learning will be occurring. In order for the intensity to stay high, the DURATION needs to be short. This means the time of each session needs to be very short. Children will learn far more math having sessions 4× a day for 5 minutes, than they will having sessions 1× a day for 20 minutes. The longer the session, the more likely it will become low intensity (boring) causing the child's brain to turn off. In addition to the short sessions which define DURATION, it also means that you need to have a lot of DURATION over time. You should have many small sessions daily over weeks and months. So DURATION means two things related to time. One is the amount of time for each session (which has to be short to keep up the INTENSITY) and the other is the length of time over which you will be daily inputting the information (which will be longer so that the child has many opportunities to learn it).

HOW WILL I KNOW HOW LONG I SHOULD WORK WITH MY CHILD? This is a common question. Some things to keep in mind—usually the younger the child the shorter the sessions should be. For children ages 2-3 you might only want sessions of 2-5 minutes. Children ages 4-7 you might need sessions of 5-10 minutes. Older children might need 10-15 minute sessions. We rarely recommend math sessions last longer than 15 minutes, even for high school students. They will learn more by taking breaks and keeping their math sessions short. These are just general guidelines. You will have to take your cues from your child. The Math N' More program is set up to have a child complete about 1-3 pages a day. Since Math N' More has many activities besides just doing math, your sessions may go longer and still remain positive. You as the parent/teacher will need to adjust it for each individual child.

One way to judge if your sessions are the correct length is to monitor the child's reaction. When you stop and put Math N' More away the child should still be WANTING to do MORE. It is very important to STOP the session with the child still WANTING MORE. If they still want more math, that means you are timing things correctly. They will be very excited for the next session of Math N' More. Keeping the sessions short and positive helps a child to learn to LOVE math.

It is a common mistake for parents to keep doing more and more in a session because the child is enjoying it and doing well. In this scenario, the session usually gets too long and the child gets tired or works until he is making mistakes and it becomes negative. You do not want to let this happen. It is helpful to work with a timer and set it ahead of time so that you know to stop when it goes off. Hopefully your child will still love math after every session.

HOW TO BEGIN: When you begin, you will complete each activity beginning at the top of the page and working down to the bottom. The details for each type of activity can be found in these instructions. If you forget how to do an activity, read the instructions again. If a specific type of activity is too difficult for your child because of a physical limitation or because of where he is developmentally, you have the option to alter it slightly so they can accomplish it, or skip that activity entirely. If you skip over the activity, go back every week and try again so that when the child is ready you can fill in that missing piece. Math N' More covers many aspects necessary to be successful at math. To the best of your ability, try to complete all the activities because they build on each other and help develop the foundational skills necessary for easy learning.

Preparations:
(1) You may want to consider laminating your flash cards to make them easier to handle and to protect them for use with younger children.
(2) A “Number of the Day” page is provided on cardstock in your Math N' More kit. Cut this page on the lines so you have 8 individual numbers. Each time you start a new number, you will place these at the child's eye level around the house in obvious places like the child's mirror, refrigerator, door etc.

LAYOUT OF PAGES: You will see boxes on each page that facilitate your use of the curriculum. You or the child will feel gratified when you check off the activities as they are completed. Every three pages contain enough frequency, intensity and activities with short duration to produce good connections in the brain. This increases brain organization, input of numerals and one to one correspondence as well as math and reading readiness skills. If you have a very young child, he might complete one page a day. A slightly older child would complete one to two pages a day and a 4-5 year old might complete one to three pages a day, depending on the child's skill level. The activities on one page can be completed in one setting or broken into several settings. The order of completing the activities is very flexible. The order varies from page to page to help add variety. Choose the order that works best for your individual situation. There are activities that require much concentration and activities that are very active. The rule of thumb when applying this curriculum is to leave them wanting more Math N' More. This means you will be stopping the work just before your child is tired of the process. Put it away cheerfully saying you will get back to it later.

You will see a sample listed below of the different activities you will encounter in Math N' More Level 1, 2 & 3. Each time you see the activity it will look slightly different on each page and each set of pages covering numbers 1-20. The name of the activity under each picture example will help you to look up the detailed instructions listed below in alphabetical order. Familiarize yourself with the descriptions of the variations to the basic activity. This is very important because the Neurodevelopmental Approach to education is very unique. Many neurodevelopmental tips are woven into the instructions of different activities. You will not get the full benefit of the Math N' More curriculum if you just assume you know what the activities are on each page. Some of the descriptions include the neurodevelopmental reason for the activity. We have found that when parents know why they are doing something, they are more likely to be motivated to get it done. For this reason, we apologize in advance, for the length of descriptions of some of the activities; however, we wanted to accomplish our goal of equipping parents with information to make a difference in their child's life.

A certificate of completion for each Math N' More Level is available for printing from the Number Tracing CD. This certificate will help in the celebration of achievement as your child moves through the Math N' More curriculum.

Throughout the instruction there will be words and phrases that are in quotes, underlined and bold. When you are working on the activity with your child, you want to limit your words to the ones instructed. Small children and those with learning challenges, typically have low auditory processing (being able to hold pieces of sequential information together such as following multi-step directions). This low processing ability causes them to get lost in too many words—so keep it short and simple! There are also specific ways of saying something that will be integrated into the other levels of the Math N' More curriculum so your child will make faster progress if he is use to this exact foundation.

INDIVIDUAL ADAPTATION: Speed of progression through the material: When you complete three pages of The Math 'N More program a day, you will complete all the Neurodevelopmental steps with the designed frequency. If your child needs to move at a slower pace, i.e. 1 or 2 pages instead of 3; be sure to do the auditory processing and cross pattern activities two times daily.

Tracing: different sizes of tracing are provided for the fine motor development of the individual child. Have the child complete as many rows of tracing commensurate with his ability.

Visual impairment: for children that are visually impaired, you may need to enlarge the pages.

Visual Distractibility: if your child is distracted by too much on the page, try placing paper on the top and bottom of the page revealing only the part you want him to focus on at the time.

Picture Reference Guide for Activities

[image]

Activity Guide and Detailed Instructions—Alphabetical Listing

| | |
|---|---|
| 1 to 1 Counting | Mom will point to the number and say, “five” then say, “Count the balls” (or whatever |
| | objects are on the page). Immediately start by placing your index finger on each object |
| | as you count from one. Then say, “Your turn”. Point to the number. Allow the child |
| | to say the number if he can (if he hesitates, just tell him the number). Say, “Count”. |
| | allow the child (or help him) to point to each object as he counts aloud. |
| | In the section 11-20 page E, you will notice they are not counting identical objects but |
| | categories of objects. Please use this opportunity to increase the child's vocabulary. |
| | After you have counted all the objects, go back to name each one for the child and talk |
| | about his categories. |
| 1 to 1 Counting | On most pages C, F and I for numbers 1-10 you will find squares on the page large |
| with Cubes | enough to place one of your linking cubes on each square. You should have more |
| | linking cubes available on the table than the number to be counted. You will take a |
| | turn first Point to the number and say, “Number?” “five, count”. You immediately |
| | start counting by placing one cube on each square as you count aloud saying, “One. |
| | two, three, four, five”. Now you sweep all the cubes off the page and say, “Your |
| | turn.” If the child is capable of doing this on his own let him. If they are not, you can do |
| | this activity with your hand over his hand. |
| | Important Note: Even when you get to the 11-20 section, you are to count the cubes |
| | first on the page and then the child will have a turn. Counting in the teens is often the |
| | trickiest and most time consuming for children in terms of mastering the task. Once |
| | they have the pattern they typically fly from 20-100. |
| A Test for | Testing process: Write sequences of objects (these can be in categories or totally |
| Appropriate | random) on a blank, white 3x5 index card (one sequence per card). You should have |
| Level of | three different sequences for each level, i.e. three sequences with 2 objects, three with |
| Auditory | 3 objects, three with 4 objects, . . . up to 7 or the current age of the child. The age of the |
| Sequences | child (up to age 7) gives you an idea of the minimum number of words he should be |
| | able to hear, process and repeat |
| | This test measures the child's ability to repeat a random sequence of words in the |
| | same order given and on the first try. He should be able to do two out of three |
| | sequences correctly, on the first try, to be considered proficient at any given level. If |
| | this is achieved, move to the next level and test each level until he is no longer able to |
| | get the sequence on the first try. |
| A Test for | Use the Basic Technique described below and continue increasing the quantity of |
| Appropriate | words given. The child must respond correctly for two out of three sequences in order |
| Level of | for that level to be considered mastered. While testing, the child's response must be |
| Auditory | correct, repeated in the same order and on the first try. You should be able to clearly |
| Sequences | identify the child's proficiency level, which is the level at which the child performs easily |
| | and comfortably. The next highest level is his therapeutic level. This is the level in |
| | which his abilities begin to break down. This is where you start your work to enhance |
| | auditory processing. As you work on this ability to process, you will see a child whose |
| | skills in following directions, verbal expression, and understanding cause and effect will |
| | be greatly enhanced. |
| A Basic | BASIC TECHNIQUE: |
| Technique for | Tell the child that you are going to say some words and you want him to repeat |
| Auditory | them in the same order. You will use random words as described in the following |
| Sequences | auditory activities. |
| | You say, “repeat, car .... boat”. When you see a series of dots like this “....”, you |
| | should pause before speaking the next word in the sequence. You might say, |
| | “thousand” quietly to yourself between each word to create the appropriate space in |
| | time. The child responds by saying “car, boat”. The child's response must be in the |
| | order you called it out to him. If the child responds incorrectly, repeat the same |
| | sequence two or three times, or until you receive a correct response. If, after four |
| | attempts, you are still not getting a correct response, say, “Good try! Let's try another |
| | one.“Then move on to the next sequence. You want this activity to be very positive |
| | and encouraging. It takes work to get the child to move up one level in processing |
| | ability but keep in mind that it is like a year of improvement every time it happens! |
| Auditory | Auditory Object Sequences: |
| Object | This activity is only for the verbal child; however, you apply the same technique |
| Sequences | verbally as you read in the Basic Technique. You will call out objects such as |
| | animals, clothing, or furniture. The number of objects you call out each time should |
| | have already been determined in the testing described above. The child responds |
| | verbally after you have given the sequence. If you say “yellow.... blue.... green”, the |
| | child says “yellow, blue, green”. You can mix words in categories or stay in the same |
| | category. Be sure to mix the order in which you call out the words, as familiar patterns |
| | can be easily memorized. |
| | 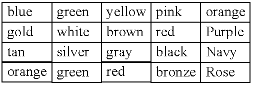 |
| Auditory Touch | Auditory Touch Sequence: |
| Sequence | This activity is for both the verbal and non-verbal child, so it can be used for |
| | toddlers, typically developing preschoolers, and older children with speech or language |
| | delays. The same Basic Technique is used here, but the instructions involve touching |
| | a series of body parts. Say, “touch nose....hair”. A correct response would be for the |
| | child to touch, in order and without assistance or visual cues, the body parts that you |
| | verbalized to him. Of course, this activity requires that the child already know and is |
| | able to identify and point to certain parts of the body. When the child can do a |
| | sequence of 2 easily, then start working on 3 auditory touch sequences. For children |
| | struggling with this activity, you might use the following actions in conjunction with |
| | touching body parts to give variety to your sequences: “wave bye-bye”, “blow kisses”, |
| | “so big”, “clap hands”. For example: “touch nose... wave bye-bye”. |
| Auditory Touch | Important Note: The child should not start the touch sequence until you have finished |
| Sequence | speaking (you may need to hold his hands). For a child who is very low processing, be |
| Additional | sure to allow enough time for him to respond without your intervention. |
| Instructions | A child who consistently gets the sequence wrong can be helped by the following: |
| | First, say the two items to touch and let him be successful. When you give him the 3 |
| | items, do the touch sequence with your hand over his hand touching each part in |
| | sequence. This is called “modeling”. Immediately after that, repeat the same three |
| | step sequence and watch and wait for him to respond on his own. If he starts to do it in |
| | the wrong order, immediately return to the modeling phase. It is very important to only |
| | verbalize before he attempts the touch sequence, not while he is doing the sequence |
| | whether it is on his own or with your assistance. |
| Auditory | Auditory Digit Span: |
| Digits | This activity is only for a verbal child. The auditory information given in this activity are |
| | digits (numbers 0-9). They should be given in random order, slowly and with pauses, as |
| | described in the Basic Technique instructions (previously). For the most part, avoid |
| | sequential numbers such as “7, 8” or “2, 3”. In addition, avoid using the |
| | same number twice in any given sequence. |
| | DON'T-(4....7....4....1) DO-(4....7....9....1) |
| | After much practice and a digit span of 5 or more has been achieved, you can begin using |
| | repeated numbers in the sequence as long as they are not in succession. |
| | DON'T-(6....4....4....7....3....1) DO-(6....4....7....3....4....1) |
| | Sample Digit Span Card: |
| | 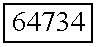 |
| | The drill is: listen. process. and then respond |
| Color by | To add variety and incorporate fine motor activities we have added Color By Number |
| Number | that will give the child more experience with number recognition and discrimination as |
| | well as following instructions to color certain numbers a certain color. If you use “stubs” |
| | (3/4″ crayons) it forces the child to use a good cortical opposition (index finger and |
| | thumb) when coloring. This technique will give more finger strength for handwriting in |
| | the future. Encourage the child to stay in the lines to the best of his ability. |
| Common | Common object counting gives additional practice in one to one counting. The objects |
| Object | mentioned are suggestions of common objects found around the house. If the |
| Counting | recommended objects are not easily accessible, substitute something you have on |
| | hand. Follow the directions in the rectangle on your page. You will hand the child the |
| | objects as you count them aloud one at a time. You could also count the objects on |
| | the table in front of him. When it is his turn, instruct the child to count the objects into |
| | your hand saying each number as he counts. |
| Coordinating | Place one cube on the shape (be sure to say the name of the shape that you are |
| Cube Count | placing the cube on) and count as you move the cube from one square to another all |
| | the way to the end. Have the child repeat what you just did, helping them if needed, to |
| | stay on each square and verbally prompting if he doesn't know the next number. Next |
| | you read the directions to him as to which number he is to place to cube on. The child |
| | follows your verbal directions by placing the cube on the square with the number you |
| | called out Underneath the “road”, you will find another set of instructions. Here the |
| | child will determine how far it is from the shape at the start to a particular square on the |
| | “road∞. Be sure the child has the cube on the shape before he starts to count This will |
| | assure the number that the child says is the number corresponding to the number on |
| | the “road”. |
| Count & | There are two boxes side by side. The first time the child sees these boxes the answer |
| Identify - | will be the same as the number being introduced on that page. The next time the |
| Choose the | objects will represent a different number and the third time there will be a different |
| Correct | number. The child will be asked, “which one is more?” The child will count the objects |
| Number | in the box and circle the number that corresponds to the number that he counted. |
| Counting CD | The counting CD is designed to move the child incrementally through the process of |
| | learning to rote count. Ideally the child should listen twice each day. If you are |
| | completing three pages a day, this frequency will be built into your activities. If you are |
| | completing only one page a day, you may want to add an additional listening |
| | time to your child's activities. Remember, frequency is one of the keys to good input |
| | to the brain. You can follow the instructions exactly as laid out on the activity pages in |
| | regard to which counting track to listen to. Conversely, you can determine your child's |
| | current proficient counting level and start working from that point. (Proficiency levels |
| | can be obtained by having the child count as far as he can on three separate |
| | occasions. If he can count to 13 one time, 12 another, and 16 another, then his |
| | proficiency level is 12 and you would start on track #3 -Counting 1-15. Proficiency is |
| | the ability to smoothly and effortlessly achieve a certain level of mastery. If the child |
| | struggles at all, you should go one step below that and build from there.) |
| Cross Pattern | The importance of cross pattern movement cannot be stressed enough. The |
| | organization of the lower levels of the brain form the foundation on which |
| | coordination and thinking skills are built. The cross pattern activities |
| | described below are induded in your child's curriculum to build that solid |
| | foundation which will spell success in your child's future. If you are only |
| | completing one or two pages a day, you will not have the frequency of cross |
| | pattern movement that is ideal for his development. Be sure that he does do |
| | cross pattern activities two times a day. |
| Cross Pattern - | The child will lay face down on the floor; he will crawl forward (army style |
| Crawl | crawl) making sure his stomach stays on the floor. The child will be moving |
| | opposite arms and legs at the same time. i.e the right arm will be extending |
| | out in front ready to pull forward and at the same time the left knee is bent |
| | and ready to push the child forward. |
| | Note: the knee doesn't need to be bent past the mid-thigh area of the straight |
| | leg. Bending the knee too far will tend to bring the child's stomach off the |
| | ground which is not desired. If the child struggles with the army crawl, try |
| | putting your hand on the bottom of his bent leg's foot to give him something |
| | to push off against. If this does not help, you can apply pressure to the |
| | bottom of his foot for added support. Once the child has mastered this skill, |
| | encourage him to move at different speeds - medium, fast and very fast. |
| Cross Pattern - | The child will be down on the floor on hands and knees. Have him move |
| Creep Forward | forward while placing opposite hand and knee on the floor at the same time. |
| | i.e. The right hand and the left knee will hit the floor at exactly the same time. |
| | If the child is having difficulty with this, you may need to get on the floor and |
| | assist him so that he knows how it feels when he does it correctly. You also |
| | could have him say something the second his arm and knee hit the floor like |
| | “down”, or “now” to get the movement coordinated. The child's hands should |
| | be flat on the floor with fingers pointed straight ahead and the head position |
| | should be looking forward. |
| Cross Pattern - | Once the child gets the creep forward down really well and has much practice with it, |
| Creep | you can move to cross creep backward. Watch your instructions in the text of the |
| Backward | curriculum for the timing of adding the cross creep backward. Have the child get down |
| | on the floor on hands and knees; he will be moving backward while placing the |
| | opposite hand and knee on the floor at the exact same time. His head should be up |
| | and hands flat on the floor, fingers pointing straight ahead. This is best done in an area |
| | like a long hail where there is a straight space and nothing for the child to run into. |
| Cross Pattern - | This is an exaggerated march (big movements). Bring left knee up high (90 |
| March | degree angle with the floor) and have the child touch his right fingertips to the |
| | front of the kneecap, then bring right knee up high and touch the left |
| | fingertips to the right knee. The arm that is not touching should be swinging |
| | down and behind the child then forward to touch again on the next cycle. |
| Deep Pressure | The brain is made up of millions of dendrites (appendages from each neuron which |
| on Hands | forms connections). When the brain is stimulated, it responds by making connections |
| | that turn into pathways. Deep pressure on hands is an activity that will increase the |
| | connection from the hand to the brain so that the brain has better control over hand |
| | function. The procedure is to start at the tip of the child's little finger and press with |
| | your index finger and thumb to the point of a pain response from the child. (Some |
| | children have a very high tolerance for pain and you will tend to think that you are |
| | pressing too hard but you have to go to the individual child's tolerance for pain. Some |
| | children have a low tolerance for pain and you will wonder why they are “over |
| | reacting”. Either reaction will be normalized over time if this activity is done |
| | consistently.) You will move up the finger from the tip, pressing on each joint, in |
| | between each joint and following the bone through the hand and all the way to the wrist |
| | area. Do each finger in succession ending with the thumb. Since the activity is one |
| | minute long, you will spent approximately 30 seconds on each hand. |
| Dexterity Circle | This activity is to give controlled practice of making circles for beginning pencil control. |
| Trace | This skill will also be used in Level 2 and 3 in preparation for adding and subtracting in |
| | Level 4. If the circles on the activity page are too small for your child's fine motor |
| | ability, you can print off the appropriate size from the Number Writing CD included in |
| | your Math N′ More kit. |
| Dexterity Dots | Dexterity dots are another way to reinforce 1-1 counting. Incorporated in this activity is |
| | the placing of a single dot, made from a dry erase marker, at the center of each square |
| | as counting takes place. If you are using the Trace Erase Board or sheet protectors, I |
| | recommend that mom do this activity first and then the child has his turn. The more |
| | continued input you can give, the faster the child will master the skill. |
| Directional | This activity begins in section 11-20. The purpose of this activity is for the child to |
| Writing | become accustomed to writing from the left side of the page to the right side. We also |
| | encourage accuracy of staying within the lines and smooth movement across the page. |
| Dot to Dot | Dot to Dots are added throughout the curriculum for fun, prewriting skills, recognition of |
| | numerical order as well as reinforcing the shapes that are being learned with the shape |
| | flash activity. There is a slightly larger circle where you will find the word start. There |
| | is also a number close to that larger dot. When you begin at the start and come back |
| | to the number beside it, the geometric figure will be complete. The child might even |
| | like to color in the shape after finishing the dot to dot |
| Finger Math - | Model the number of fingers shown in the picture. Have the child hold up the same |
| Hold up | number of fingers. Sometimes you can have the child count your fingers and |
| Certain # of | sometimes he can count his own to make sure he is holding up the correct number of |
| Fingers | fingers. |
| Finger Math - | This activity is to give the child experience making the same number with different |
| This & That | combinations of fingers. With this early experience, he will have an easier time |
| Way | understanding number combinations. |
| Finger Math - | Model for the child the number of fingers to raise on each hand. Have the child copy |
| Which is More | you. Encourage him to look at each hand to determine which is more, the fingers held |
| | up on the right hand or the left? Repeat the problem by saying “three fingers and five |
| | fingers, which one has more'?” |
| Finger Math - | As you read the word problems you will model the number of fingers that are raised. |
| Word | The child will follow your lead and put up the correct number of fingers. With addition, |
| Problems | place the number of fingers mentioned on one hand and the second number mentioned |
| | on the other hand. Have the child count all the fingers to determine the answer. Now |
| | state the problem and the answer. When doing subtraction, you will hold up the |
| | number of fingers in the problem and then fold the number of fingers to be taken away. |
| | Compare your fingers with those in the picture. State the problem as you act out the |
| | quantity and amount taken away. The child will now count what is left. |
| Flash - Basic | 1) Hold the flash cards facing you and then rotate them until they are upside |
| Technique | down and still facing you |
| (to be used | 2) Fan cards so that you can easily and quickly grab each one. |
| with all flash | 1) While holding the fanned flash cards in your left hand, place the fingers of your |
| activities) | right hand in the blank space of the flash card closest to you with your thumb on |
| | the back of the card. (Reverse if you are left handed) Then, flip the card into a full |
| | vertical position facing the child. Tell the child what the number, word or shape is |
| | and place the card face down on the table. Move through the whole stack |
| | inputting the information, shuffle the stack and repeat After going through the |
| | deck two times you can play “the game” by putting 2 cards (4 cards for older |
| | children) face up on the table. You will ask the child to identify by pointing to the |
| | card that you call out. Ex: You say, “Find the 2”, The child points to the card with |
| | the 2 on it. If the child is not correct in his choice, tell him the name of the one he |
| | pointed to and then show him the correct card. If he was successful, use verbal |
| | and physical praise (“way to go!, you are so smart!, right again!, high fives, hugs |
| | etc.) |
| | 2) Remember that this flash session typically lasts for only 1 minute. Resist the urge |
| | to spend more time on this activity. More is not better in this case and will lower |
| | the intensity as well as the child's willingness to participate again. Remember to |
| | leave him wanting more, Math N′ More! |
| Flash - | Use the BASIC FLASH TECHNIQUE for Number Flash. You will flash the numerals |
| Number | that are specified in the activity box on each level of the program. The progression |
| | schedule is designed to give adequate INPUT (being told or shown) so the child will |
| | have no problem with OUTPUT (telling you from memory). You can move ahead of the |
| | schedule if your child already knows the numbers but be careful about asking for output |
| | too early. If a child is struggling with recall you need to stay longer on the flash of the |
| | current set of numerals. |
| Flash - | You will use the BASIC FLASH TECHNIQUE to do the word flash activity. Start with 2 |
| Number Word | words the first day. Flash the word and say what it is. Do this 4-5 times and then play |
| | “the game”. |
| Flash - Shape | Use the BASIC FLASH TECHNIQUE for the Shape Flash. Shapes will be introduced |
| | one at a time through the first part of Level 1. The order to introduce the shapes are: |
| | line, triangle, square, diamond, pentagon, star, rectangle, octagon, circle, oval and |
| | heart. The number of shapes to be flashed each session is specified on the activity |
| | pages. Show the child the new shape and name it. Then place that shape in the stack |
| | with the other shapes. Go through the stack 4-5 times, in a different order each time, |
| | when there are just a few shapes. As the number of shapes increase, the number of |
| | times through the stack will diminish. Remember, this activity focuses on 90% input, so |
| | you are telling the child on each flash. If they say it after you, that is permitted but |
| | Shape should not be required. Note: These shapes are also reinforced with the dot to dot |
| | activities. |
| Household | This activity is another way to let children know that you can count everything. This |
| Counting | also builds movement into your Math N′ More sessions. Feel free to substitute |
| | something different for the child to count if the suggestion on your page is not |
| | applicable to your situation. The child should count the objects requested and report |
| | back to you the quantity he discovered. |
| More or Less | In the first section, which covers numbers 1-5, you will see two boxes which we refer to |
| Discrimination | as Count & Identify. On page H of each number section, there will be an addition to the |
| | boxes seen previously. Here, after you have been asked to identify the number of |
| | objects in each box by circling the correct number, you will then be asked to circle the |
| | one that is more (or less). Encourage the child to look at each box and see if he can |
| | tell which box has more objects. Read the child the instructions to “circle the one that |
| | is more, “5 or 2.” |
| | In the section which covers numbers 6-10, the boxes are replaced by towers or roads |
| | of squares. The child counts the squares, wiltes (or has you write) the number on the |
| | blank and then you read the instructions, “Which is more?”. Then he circles it. You |
| | want to draw the child's attention to the fact that the one that has more is taller or |
| | longer than the other one. |
| More or Less | In section 11-20, there will be three boxes. Inside each box you will find two groups of |
| Discrimination | objects that have the same shape. Have the child look at each group in the box. Ask if |
| Section 11-20 | he can see which group has more (or less depending on the directions). Have the child |
| | count to make sure he was correct in his observation and then he circles the group that |
| | has more. After that you say the “conclusion” aloud for the child to hear. i.e. The child |
| | has counted 4 in one group and 2 in another group. You will say, “4 is more than 2”. |
| Number of The | The Number of the Day page is to be cut into 8 separate pieces with a number on |
| Day | each. Place each number around the house at the child's eye level (whenever |
| | possible). When the detective on your activity page says, “Find the number of the day” |
| | the child should move through the house spotting as many of the numerals as he can |
| | find. Encourage the child to say the name of the number every time he finds one. To |
| | add intensity, you can move the numerals to different spots each day. The particular |
| | number of the day located throughout the house remains visible as long as the child is |
| | working on that number. Older children may want to trace over the numerals as they |
| | find them for added writing practice. |
| Number of the | Purpose: many children struggle with counting the teen numbers. This activity is to get |
| Day - Count | them used to the pattern in incremental steps. They have been heating the correct |
| From 10 | pronunciation and sequencing of these on the counting CD and now they will have a |
| | chance to practice the new skill. |
| | Procedure: Starting with 11, when your child finds the Number of the Day, he will say |
| | the number and then count from 10 to the number they are currently working on. Ex. |
| | When the child sees 15, he will say 15 (if they can't remember the number, you tell |
| | them what it is). Then count from 10 to 15, saying each number aloud, 10, 11, 12, 13, |
| | 14, 15! You can model this for him if you need to by doing the example above followed |
| | by the child repeating what you just demonstrated. |
| Number | There is a disc for your computer in the Math N′ More box. There are five different |
| Tracing | pages available on the disc for each numeral as well as a page for writing the number |
| | word. You can use these different size font options to print the page that best fits your |
| | child's fine motor ability. You make the choice to have the child trace 1, 2 or 3 rows of |
| | the number depending on the child's ability level and attention span. There is a short |
| | quote for him to say when he is writing the number to solidify the correct formation of |
| | each numeral. For a time, encourage him to say this aloud as he writes each number. |
| Pattern | Starting in section 11-20, you will find patterns for the child to study and then to choose |
| Identification | which one comes next in the pattern. It is often helpful for the child to say the picture |
| | out loud so he can hear and see the pattern emerging and when he is at the end of the |
| | row (before the triple dividing lines). They will be able to pick the one that goes next |
| | When you get to 16, the patterns become more complicated. |
| Shape | The child will look at the row of objects and cirde the ones that are the same. At first |
| Discrimination | he will have only one row with three objects. This will become harder as he moves |
| | through the curriculum. In section 11-15 there will only be one shape that is the same |
| | as the first one but many more shapes are presented for him to choose from. In the |
| | section coveting the numbers 16-20 the discrimination will be more complex. There |
| | will be several shapes that are the same but they are at different angles. This activity |
| | is to help the child see basic shapes in every day observations. |
| Stories on tape | One of the most important skills children can have is the ability to listen and hold pieces |
| or CD | of auditory information. This skill is essential to following directions, comprehension |
| | and utilization of phonics. Listening to stories on tape or CD is a very productive |
| | activity to develop the auditory skills necessary to be successful in life. We cannot |
| | emphasize the importance of this activity enough. These activities should be High |
| | interest stories on tape or CD (High interest is the key to the success of this activity.) |
| | The more they listen the better their processing becomes and the higher the function |
| | you will see. Do you need a way to positively occupy a younger child while you are |
| | busy with other duties? Try stories on tape instead of TV. You will see many more |
| | benefits for your child long term. Other benefits from hours a day spent listening to |
| | stories are: increased vocabulary, improved comprehension, attention span expanded, |
| | and sequential thinking enhanced. |
| | If you are certain of your child's hand dominance, you can add more benefit to this |
| | activity by having the child listen in one ear only. The ear that is on the same side of |
| | an already established dominant hand is the one that you would want them to listen |
| | with. The rational behind the importance of listening in the dominant ear only is too |
| | lengthy to explore here. Briefly though, it is best to reinforce the ear on the same side |
| | as the hand. This insures that information is stored in the language center for easy |
| | access at a later date. Both ears hear but one determines where auditory information |
| | is stored in the brain. If the child is too young to have dominance established or it the |
| | child is still mixed handed (doing things like eating, brushing teeth and writing with both |
| | hands) the stories should be listened to with both earphones or through speakers. |
| Visual | Visual discrimination is presented early in the text. The child looks at the box and |
| Discrimination | determines the object that is not exactly like the others. He then puts an x or points to |
| | the one that is not the same. The complexity of the task increases as you move |
| | through each section. |
| | In section 11-15, more variation is offered so that the choice of what doesn't belong |
| | takes more fine tuned discrimination. i.e. on page 12E the child will find several circles, |
| | ovals and one square. They would have determined that the square does not belong |
| | because it has straight sides and the other shapes do not have any sides. |
| | In section 16-20 categories are introduced and the child has to determine from all |
| | unlike objects which one does not belong because is does not have a category in |
| | common with the rest of the objects. |
| Visual Object | For this activity you will use small objects or pictures of objects (A Memory Game |
| Sequence | works great). Place three of the objects or pictures on the table in front of child |
| | (starting at their left, and going to the right). Then point to each object. Cover the |
| | objects or pictures with a file folder or piece of dark construction paper, cardboard, etc. |
| | Then have the child name each object or picture in the order presented (left to right). |
| | After the child can do 3 consistently, for several days, bridge to 4. To bridge, follow the |
| | procedure above. After the child correctly names the three objects, uncover them and |
| | place one more object or picture on the table after the last object. Then point (be sure |
| | not to say anything) to all 4 objects, starting from his left and going to the right, then |
| | cover them up. After the child can bridge to 4 consistently, start giving him 4 objects |
| | before you cover them and ask for a response. The child should tell you each of the |
| | objects in order from left to right If he starts to give an incorrect response, uncover the |
| | objects immediately and point to each one again. Cover and give another opportunity |
| | for him to say each one in order. |
| Visual Digit | You can use the same cards you use for the Auditory Digit Span in this activity; |
| Span | however, substitute these instructions: Hold the digit card in front of the child |
| | for 3 seconds (say “thousand” silently to yourself between each number to |
| | insure proper timing). Then put the card down. At that point, the child tells |
| | you the numbers from left to right. If he replies incorrectly, you may try the |
| | same sequence up to 3 or 4 times, then move on to a different sequence. |

Math N' More Math Facts In A Flash Addition Module—Math N' More Math Facts In A Flash has a very unique format. It includes intense visual, auditory and tactile input to the brain so math facts are learned quickly and retained long term. Input (instruction), with frequency (how often), intensity (how strong) and controlled duration (how much time per session and over enough days), is the key to success. Please read and follow these instructions carefully. 0+ and 1+ math facts will be taught first and in a slightly different format from the other facts.

Getting Started: Read all instructions (pages 1-4) before starting and review the contents of this package.

Detailed Instructions

CD with 2 min. tracks of specific math facts

Discovery Game Answer Sheets

Flash Cards

Speed Drills

Daily Tracking Sheet

Sheet Protector

Make sure you have the following supplies: a 3-ring notebook with pockets to keep your math facts system organized, a CD player, headphones (recommended, but optional), a dry erase marker (fine point, black is preferred) and a stop watch.
(1). Flash Card Cutting Instructions: Cut all flash cards the same size as the sample provided. The space at the bottom of the flash cards should not be removed as it allows you to handle the cards easily without having your fingers covering the information when flashing. You may want to laminate the flash cards for easier handling and to preserve for later use with younger children. (Laminating is available at many teacher supply stores.) Do not use clear contact paper as it tends to make the flash cards stick together which interferes with the speed necessary for intensity.
(2) Copy Answer Sheets and Speed Drills if not using dry erase method (see below).
(3) Note: For older children you can move through the first two weeks procedures very rapidly. It may only take 2 days, as long as they understand the concepts.

Week 1—Teaching Addition Facts With 0:
(1) Step 7: Begin with the following explanation: “Zero plus any number is that same number. If you have five cookies and mom gives you zero, or, no more cookies, you still have five cookies. If you have three cars and Dad gives you zero, or, no more cars, you still have three cars”. Have these conversations with your child throughout the day all during the week, i.e. dinner table (with plates, food and people), with blocks, with videos, etc.
(2) Step 2: Now, take this explanation to written form. On a dry erase board or a blank piece of paper, write, three 0+ problems, saying the answer as you write. Example: write 6+0=6, while saying, “Six plus zero equals six.” Then write, 9+0=9 while saying, “Nine plus zero equals nine.” Do the same for the third problem. (This is considered 75% instruction-you are doing three to every one the child does.) Refrain from any other verbal explanation. More is not better! Then say, “Your turn”. (procedure explained in Step 3)
(3) Step 3: Write one problem, then give child the marker, or pencil, so they can write the answer for themselves without your input. After child does this one problem, repeat step 2 with 75% instruction, then child does another problem as described in step 3.

Spend two to three minutes (maximum). You want to leave the child wanting more. Do this two times a day for four days with the described 75% instruction, even if your child seems to know the answers before day five. (Exception: By day three or four, if child is understanding process well, you can move to the following Step 3 variation.)

Step 3 variation: Parent does one problem (instead of three) then, child does the next problem, (this is considered 50% instruction.). Remember: Input is crucial to success. If the child does all the problems, that is 100% OUTPUT otherwise known as a “Test”. Testing has its place but this is not it. Your child may want to make up their own problems toward the end of the week. This is fine, but only when it is their turn.

All ten 0+ problems should be presented in the format outlined below. You can repeat problems if time allows:

| Day 1: | Day 2: | Day 3: | Day 4: | Day 5: |
|---|---|---|---|---|
| 6 + 0 | 6 + 0 | 6 + 0 | 6 + 0 | 0 + Speed Drill |
| | 0 + 6 | 0 + 6 | 0 + 6 | |
| | | 6 + 0 | 6 + 0 | |
| | | | 0 + 6 | |

Speed Drill Instructions:
(1) 0+ Speed Drill is introduced on day 5 of the 0+training. Continue using this Speed Drill each day while teaching the 1+facts described under Week 2 below.
(2) Use sheet protectors (provided) and dry erase markers for multi day use of Speed Drill or make copies for your families' use.
(3) Have child write all answers as fast as he can. Tell your child, “Don't try to figure out the answers, just write them from memory. If you don't know the answer, skip that problem and go on to the next one.” (Note: Blank answers are your cue that he needs more input.)
(4) Mark all problems that are correct with a star or check mark. (An answer key is provided on green paper.) Count all correct answers and tell the child to try to beat their score each day. Goal: 3 days of 100%.
(5) The Speed Drill builds from week to week. As more facts are learned, they appear on the Speed Drill Sheets for review. There is no time limit on a Speed Drill, however, the child should try to beat his own time and accuracy score from day 1 to day 5 of each week. This adds intensity! A stopwatch would be helpful here.

Week 2—Teaching Addition Facts with 1:
(1) Step 7: Younger or less experienced children use the “Number Sequence” worksheet. Procedure for use: On the first day, the parent writes three answers for every one answer the child writes. Example: Mom sees 5 _; mom writes 6 in the blank as she says, “five, six”. She does this for three of the numbers on the sheet. (75% instruction) The child fills in the next blank. (If the child has no problem with this concept move on to the written problems as described in step 2, below.) If more practice is needed proceed on the second day of the Number Sequence worksheet as follows: the parent writes two answers for every one answer the child writes. (66% instruction) On the third day, the parent writes one answer for every one answer the child writes. (50% instruction) Repeat worksheet for several days, each time in a different order, i.e. start at the top one day; start at the bottom and work up; one day go from left to right. Don't ever go below 50% instruction. Do this Number Sequence until the child's response is automatic. Practical application of this procedure around the house as described in 0+ explanations would also be very helpful. i.e. “I gave you 2 crackers. If I give you one more you will have _”. Time on step 1 will vary for each child. As soon as the concept is learned move on to step 2.

(2) Step 2: Older children can start with this step. Teach the concept: “One plus any number is like counting to the next highest number”. Use a dry erase board or a plain piece of paper to input all formats of 1+ as you did in 0+ explanation. (See table below.) Be sure to say, “Five plus one equals six” with no more words added. Remember days 1-4 are days to input 1+ and reinforce previous knowledge with the 0+ Speed Drill

| Day 1: | Day 2: | Day 3: | Day 4: | Day 5: |
|---|---|---|---|---|
| 5 + 1 | 5 + 1 | 5 + 1 | 5 + 1 | 1 + Speed Drill |
| | 1 + 5 | 1 + 5 | 1 + 5 | |
| | | 5 + 1 | 5 + 1 | |
| | | | 1 + 5 | |
| 0 + Speed | 0 + Speed | 0 + Speed | 0 + Speed | |
| Drill | Drill | Drill | Drill | |

Now you are ready to start the complete multi-sensory aspect of Math N' More Math Facts In A Flash Addition Module. The next few weeks will be a different format than the first 2 weeks.

Overview of Daily Procedure:

| Activity | Duration |
|---|---|
| Listen only to track with math facts | 2 minutes |
| Listen to same track and fill in answers on corresponding | 2 minutes |
| yellow Answer | |
| Sheet (match symbol on track to symbol on Answer Sheet) | |
| Math Facts Flash Card session with mom (match symbol) | 1 minute |
| Math Facts Flash Card session with mom (same cards as | 1 minute |
| above) | |
| Speed Drill (match symbol on track with symbol on Speed | 1 minute |
| Drill) | (approx.) |

Addition Track Reference Table

| | | | | | | |
|---|---|---|---|---|---|---|
| [symbol] | Track 1 | 2 + 2 = 4 | 3 + 5 = 8 | 5 + 3 = 8 | 4 + 5 = 9 | 5 + 4 = 9 |
| [symbol] | Track 2 | 2 + 5 = 7 | 2 + 7 = 9 | 7 + 2 = 9 | 4 + 6 = 10 | 6 + 4 = 10 |
| Δ | Track 3 | 3 + 2 = 5 | 2 + 6 = 8 | 6 + 2 = 8 | 3 + 7 = 10 | 7 + 3 = 10 |
| [symbol] | Track 4 | 3 + 4 = 7 | 3 + 6 = 9 | 6 + 3 = 9 | 4 + 7 = 11 | 7 + 4 = 11 |
| # | Track 5 | 4 + 2 = 6 | 5 + 7 = 12 | 7 + 5 = 12 | 2 + 9 = 11 | 9 + 2 = 11 |
| ♥ | Track 6 | 3 + 3 = 6 | 2 + 8 = 10 | 8 + 2 = 10 | 3 + 9 = 12 | 9 + 3 = 12 |
| ∞ | Track 7 | 4 + 4 = 8 | 3 + 8 = 11 | 8 + 3 = 11 | 4 + 9 = 13 | 9 + 4 = 13 |
| ⋄ | Track 8 | 5 + 5 = 10 | 4 + 8 = 12 | 8 + 4 = 12 | 5 + 9 = 14 | 9 + 5 = 14 |
| □ | Track 9 | 6 + 6 = 12 | 6 + 8 = 14 | 8 + 6 = 14 | 7 + 9 = 16 | 9 + 7 = 16 |
| + | Track | 7 + 7 = 14 | 5 + 8 = 13 | 8 + 5 = 13 | 6 + 9 = 15 | 9 + 6 = 15 |
| | 10 | | | | | |
| Ω | Track | 8 + 8 = 16 | 5 + 6 = 11 | 6 + 5 = 11 | 7 + 8 = 15 | 8 + 7 = 15 |
| | 11 | | | | | |
| Π | Track | 9 + 9 = 18 | 6 + 7 = 13 | 7 + 6 = 13 | 8 + 9 = 17 | 9 + 8 = 17 |
| | 12 | | | | | |

Math Facts 2+ and up: Each day for one week, your child will listen to the same track of specific facts. He will also see flashcards with these same facts and complete Speed Drills reviewing previously learned facts.

Track 1: (This is the template to be used on all tracks)—Have your child listen to the 2-minute track, twice a day (preferably one to four hours apart). One time, the child lust listens. The next time, have him fill in the answers on the yellow Answer Sheet with the corresponding symbol for the current track. The child listens to the CD, finds the problem on the first row and writes the answer. Each row should be completed before moving to the next row. The facts on the sheet are in a different order from the CD. This adds intensity because they have to listen carefully and hunt for the problem before writing the answer. Neurodevelopmental Hint: To make the long-term memory of facts more effective, listen to the CD in one ear only. Choose the ear that matches the child's dominant hand, (the one they write with). During flash sessions, patch the eye opposite the dominant hand. For more information on dominance, see articles on our web site at www-littlegiantseps.com or email us at lgssupport@comcast.net

Flash Card Input Session: Follow these directions two times a day for 1 minute each time. (If possible separate each flash session by at least 30 minutes.
(1) 1) Separate the 5 flash cards with the same symbol as the track you are working on.
(2) Flash these cards, using the technique described below, as fast as the child can read them (make sure the answer is showing—Remember—Input). Speed helps with intensity and gives time for more input.
(3) Mix the order of flash cards and repeat flash with child reading as fast as before.
(4) Mix the order of flash cards again. This time cover the answer, have the child read the problem and then give the answer from memory (output). If he/she hesitates, just show the answer and have them read it quickly again. This flash session should take 1 to 1½ minutes (maximum). Remember, more is not better, but frequency and intensity, over time, makes all the difference.
(5) Optional Review: One time a week, flash all previously learned facts with 66% input. Procedure: Child reads two cards with answer showing, and then the third card the answer is covered while they read and answer from memory. Change the order of cards for each weeks review.

Flash Card Technique:
(1) Hold the flash cards facing you and then rotate them until they are upside down.
(2) Fan cards so that you can easily and quickly grab each one.
(3) While holding the fanned flash cards in your left hand, place the fingers of your right hand in the blank space of the flash card closest to you with your thumb on the back of the card. (Reverse if you are left handed) Then, flip the card into a full vertical position facing the child. Have the child read the card as fast as possible, then place the card face down on the table in front of you and immediately flip the next flash card.

Suggested Daily Schedule: Use Daily Tracking Sheet (make copies of the one provided) to help keep track of all steps of the Math N' More Math Facts In A Flash system each day.
(1) Early morning—Listen only to the specific track for that week.
(2) 10 plus minutes later—1^{st} flash card session with 5 facts corresponding to track on CD
(3) Mid to late morning—2^{nd} flash card session (same facts)
(4) After lunch—While listening to same track as in the morning, record answers on corresponding yellow Answer Sheet. (There should be at least 10 to 15 minutes between listening and flash sessions.)

(5) Speed Drill can be done any time of day because it is a review of previous weeks. Be sure to use Speed Drill with the same symbol as the CD track for that week.
After the child has done all the tracks, have him redo any tracks containing facts where recall is not automatic.

Math N' More Math Facts In A Flash Subtraction Module

Math N' More Math Facts In A Flash has a very unique format. It includes intense visual, auditory and tactile input to the brain so math facts are learned quickly and retained long term. Input (instruction), with frequency (how often), intensity (how strong) and controlled duration (how much time per session and over enough days), is the key to success. Please read and follow these instructions carefully. −0 and −1 math facts will be taught first and in a slightly different format from the other facts.

Getting Started: Read all instructions (pages 1-4) before starting and review the contents of this package.

Detailed Instructions

CD with 2 min. tracks of specific math facts

Discovery Game Answer Sheets

Flash Cards

Speed Drills

Daily Tracking Sheet

Sheet Protector

Make sure you have the following supplies: a 3-ring notebook with pockets to keep your math facts system organized, a CD player, headphones (recommended, but optional), a dry erase marker (fine point, black is preferred) and a stop watch.

Copy Answer Sheets and Speed Drills if not using dry erase method (see below).

Note: For older children you can move through the first two weeks procedures very rapidly. It may only take 2 days, as long as they understand the concepts.

Week 1—Teaching Subtraction Facts With 0:

Step 1: Begin with the following explanation: “Any number minus zero is that same number. If you have five cookies and mom takes away zero, or, no cookies, you still have five cookies. If you have three cars and Dad takes away zero, or, no cars, you still have three cars”. Have these conversations with your child throughout the day all during the week, i.e. dinner table (with plates, food and people), with blocks, with videos, etc.

Step) 2: Now, take this explanation to written form. On a dry erase board or a blank piece of paper, write, three. A problems, saying the answer as you write. Example: write 6−0=6, while saying, “Six minus zero equals six.” Then write, 9−0=9 while saying, “Nine minus zero equals nine.” Do the same thing for the third problem. (This is considered 75% instruction-you are doing three to every one the child does.) Refrain from any other verbal explanation. More is not better! Then say, “Your turn”.

Step 3: Write one problem, then give child the marker, or pencil, so they can write the answer for themselves without your input. After child does this one problem, repeat step 2 with 75% instruction, then child does another problem as described in step 3.

Spend two to three minutes (maximum). You want to leave the child wanting more. Do this two times a day for four days with the described 75% instruction, even if your child seems to know the answers before day five. (Exception: By day three or four, if child is understanding process well, you can move to the following variation.)

Step 3 variation: Parent does one problem (instead of three) then, child does the next problem, (this is considered 50% instruction). Remember: Input is crucial to success. If the child does all the problems that is 100% OUTPUT otherwise known as a “Test”. (Testing has its place, but this is not it. (Your child may want to make up their own problems toward the end of the week. This is fine, but only when it is their turn.

All ten −0 problems should be presented in the format outlined below. You can repeat the same problem if time allows:

| Day 1: | Day 2: | Day 3: | Day 4: | Day 5: |
|---|---|---|---|---|
| 6 − 0 | 6 − 0 | 6 − 0 | 6 − 0 | −0 Speed Drill |
| | | 6 − 0 | 6 − 0 | |

Speed Drill Instructions:
(1) −0 Speed Drill is introduced on day 5 of the −0 training. Continue using this Speed Drill each day while teaching the −1 facts described under Week 2.
(2) Use sheet protectors and dry erase markers for multi day use of Speed Drill or make copies for your families' use.
(3) Have child write all answers as fast as he can. Tell your child, “Don't try to figure out the answers, just write them from memory. If you don't know the answer, skip that problem and go on to the next one.” Blank answers are your cue that your child needs more input.
(4) Mark all problems that are correct with a star or check mark. (An answer key is provided on green paper) Count correct answers and tell the child to try to beat their score each day. Goal: 3 days of 100%. (not required to proceed)
(5) The Speed Drill builds from week to week. As more facts are learned, they appear on the Speed Drill Sheets for review. There is no time limit on a Speed Drill, however, the child should try to beat his own time and accuracy score from day 1 to day 5 of each week. This adds intensity! A stopwatch would be helpful here.

Week 2—Teaching Subtraction Facts with 1:

Step 1: Younger or less experienced children use the “Number Sequence” worksheet

Procedure for use: On the first day, the parent writes three answers for every one answer the child writes. Example: Mom sees _{—}5; mom writes 4 in the blank as she points to each and says, “4, 50. She does this for three of the numbers on the sheet. (75% instruction) The child fills in the next blank (If the child has no problem with this concept move on to the written problems as described in step 2, below.) On the second day of the Number Sequence worksheet, the parent writes two answers for every one answer the child writes. (66% instruction) On the third day, the parent writes one answer for every one answer the child writes. (50% instruction) Repeat worksheet for several days, each time in a different order, i.e. start at the top one day; start at the bottom and work up; one day go from left to right. Do this until the child's response is automatic. Practical application of this procedure around the house as described in −0 explanations would also be very helpful. i.e. “I gave you 2 crackers. If I take away 1 cracker you will have _.” Time on step 1 will vary for each child. As soon as the concept is learned move on to step 2.

Step 2: Older children can start with this step. Teach the concept: “One minus any number is like counting backward”. Use a dry erase board or a plain piece of paper to input all formats of −1 as you did in −0 explanation. See table pg 3. Be sure to say, “Five minus one equals four” with no more words added. Remember days 1-4 are days to input −1 and reinforce knowledge with the −0 Speed Drill

| Day 1: | Day 2: | Day 3: | Day 4: | Day 5: |
|---|---|---|---|---|
| 5 − 1 | 5 − 1 | 5 − 1 | 5 − 1 | −1 Speed Drill |
| | | 5 − 1 | 5 − 1 | |
| −0 | −0 | −0 | −0 | |
| Speed Drill | Speed Drill | Speed Drill | Speed Drill | |

Now you are ready to start the complete multi-sensory aspect of Math N' More Math Facts In a Flash Subtraction Module. The next few weeks will be a different format than the first 2 weeks.

Overview of Daily Procedure:

| Activity | Duration |
|---|---|
| Listen only to track with math facts | 2 minutes |
| Listen to same track and fill in answers on corresponding | 2 minutes |
| yellow Answer | |
| Sheet (match symbol on track to symbol on Answer Sheet) | |
| Math Facts Flash Card session with mom (match symbol) | 1 minute |
| Math Facts Flash Card session with mom (same cards | 1 minute |
| as above) | |
| Speed Drill (match symbol on track with Speed Drill) | 1 minute |
| | (approx.) |

| | | | | | | |
|---|---|---|---|---|---|---|
| [symbol] | Track 1 | 3 − 2 = 1 | 5 − 2 = 3 | 5 − 3 = 2 | 7 − 2 = 5 | 7 − 5 = 2 |
| [symbol] | Track 2 | 4 − 3 = 1 | 6 − 2 = 4 | 6 − 4 = 2 | 8 − 3 = 5 | 8 − 5 = 3 |
| Δ | Track 3 | 5 − 4 = 1 | 7 − 3 = 4 | 7 − 4 = 3 | 8 − 2 = 6 | 8 − 6 = 2 |
| [symbol] | Track 4 | 6 − 5 = 1 | 9 − 2 = 7 | 9 − 7 = 2 | 10 − 3 = 7 | 10 − 7 = 3 |
| # | Track 5 | 7 − 6 = 1 | 9 − 4 = 5 | 9 − 5 = 4 | 10 − 2 = 8 | 10 − 8 = 2 |
| ♥ | Track 6 | 8 − 7 = 1 | 9 − 3 = 6 | 9 − 6 = 3 | 11 − 6 = 5 | 11 − 5 = 6 |
| ∞ | Track 7 | 9 − 8 = 1 | 11 − 3 = 8 | 11 − 8 = 3 | 10 − 4 = 6 | 10 − 6 = 4 |
| ⋄ | Track 8 | 10 − 9 = 1 | 11 − 2 = 9 | 11 − 9 = 2 | 12 − 5 = 7 | 12 − 7 = 5 |
| □ | Track 9 | 4 − 2 = 2 | 11 − 4 = 7 | 11 − 7 = 4 | 12 − 3 = 9 | 12 − 9 = 3 |
| + | Track | 6 − 3 = 3 | 12 − 4 = 8 | 12 − 8 = 4 | 13 − 6 = 7 | 13 − 7 = 6 |
| | 10 | | | | | |
| Ω | Track | 8 − 4 = 4 | 13 − 8 = 5 | 13 − 5 = 8 | 15 − 9 = 6 | 15 − 6 = 9 |
| | 11 | | | | | |
| Π | Track | 10 − 5 = 5 | 13 − 4 = 9 | 13 − 9 = 4 | 14 − 8 = 6 | 14 − 6 = 8 |
| | 12 | | | | | |
| $ | Track | 12 − 6 = 6 | 14 − 5 = 9 | 14 − 9 = 5 | 17 − 8 = 9 | 17 − 9 = 8 |
| | 13 | | | | | |
| ¢ | Track | 14 − 7 = 7 | 16 − 7 = 9 | 16 − 9 = 7 | 15 − 8 = 7 | 15 − 7 = 8 |
| | 14 | | | | | |

Subtraction Track Reference Table

Math Facts 2—and up: Each day for one week, your child will listen to the same track of specific facts. He will also see flashcards with these same facts and complete Speed Drills reviewing previously learned facts.

Track 1: (This is the template to be used on all tracks) Have your child listen to the 2-minute track, twice a day (preferably one to four hours apart). One time, the child Lust listens. The next time, have him rill in the answers on the yellow Answer Sheet with the corresponding symbol for the current track. The child listens to the CD, finds the problem on the first row and writes the answer. Each row should be completed before moving to the next row. The facts on the sheet are in a different order from the CD. This adds intensity because they have to listen carefully and hunt for the problem before writing the answer.

Neurodevelopmental Hint: To make the long-term memory of facts more effective, listen to the CD in one ear only. Choose the ear that matches the child's dominant hand, (the one they write with). During flash sessions, patch the eye opposite the dominant hand.

Flash Card Input Session: Follow these directions two times a day. (If possible separate each session by at least 30 minutes)
(1) Separate the 5 flash cards with the same symbol as the track you are working on.
(2) Flash these cards, using the technique described below, as fast as the child can read them (make sure the answer is showing—Remember—Input). Speed helps with intensity and gives time for more input.
(3) Mix the order of flash cards and repeat flash with child reading as fast as before
(4) Mix the order of flash cards again. This time cover the answer, have the child read the problem and then give the answer from memory. If he/she hesitates, just show the answer and have them read it quickly again. This flash session should take 1 to 1 Y minutes (maximum). Remember, more is not better, but frequency and intensity, over time, makes all the difference.
(5) Optional Review: One time a week, flash all previously learned facts with 66% input.
(6) Procedure: Child reads two cards with answer showing, and then the next card, the answer is covered while they read and answer from memory. Continue through deck, with two input cards then one output card. Change the order of cards for each weeks review.

Flash Card Technique:
(1) Hold the flash cards facing you and then rotate them until they are upside down.
(2) Fan cards so that you can easily and quickly grab each one.
(3) While holding the fanned flash cards in your left hand, place the fingers of your right hand in the blank space of the flash card closest to you with your thumb on the back of the card. (Reverse if you are left handed) Then, flip the card into a full vertical position facing the child. Have the child read the card as fast as possible, then place the card face down on the table in front of you and immediately flip the next flash card.

Suggested Daily Schedule: Use Daily Tracking Sheet (make copies of the one provided) to help keep track of all steps of the Math N' Facts Math Facts In A Flash Subtraction system each day.
(1) Early morning—Listen only to specific track for that week.
(2) 1^{st} flash card session with 5 facts corresponding to track on CD
(3) Mid to late morning—2^{nd} flash card session (same facts)
(4) After lunch—While listening to same track as in the morning, record answers on corresponding yellow Answer Sheet (There should be at least 10 to 15 minutes between listening and flash sessions.)
(5) Speed Drill can be done any time of day because it is a review of previous weeks. Be sure to use Speed Drill with the same symbol as the CD track for that week.
   After child has done all the tracks, have him redo any tracks containing facts when recall is not automatic.

Daily Tracking Sheet

[image]

Number Sequence Worksheet

Fill in the blank with the number that comes before the number in each box.

| | | |
|---|---|---|
| 5 | 7 | 0 |
| 9 | 33 | 2 |
| 12 | 6 | 9 |
| 2 | 14 | 5 |
| 0 | 3 | 7 |
| 8 | 10 | 4 |
| 25 | 4 | 6 |
| 1 | 8 | 3 |

Math N' More Math Facts In A Flash Multiplication Module

Math N' More Math Facts In A Flash Multiplication Module has a very unique format. It includes intense visual, auditory and tactile input to the brain so math facts are learned quickly and retained long term. Input (instruction), with frequency (how often), intensity (how strong) and controlled duration (how much time per session and over enough days), is the key to success. Please read and follow these instructions carefully. 0 times and 1 times math facts will be taught first and in a slightly different format from the other facts.

Getting Started:

Read all instructions (pages 1-4) before starting and review the contents of this package.

Detailed Instructions
CD with 2 min. tracks of specific math facts
Discovery Game Answer Sheets
Flash Cards
Speed Drills
Daily Tracking Sheet
Sheet Protector
1) Make sure you have the following supplies: a 3-ring notebook with pockets to keep your math facts system organized, a CD player, headphones (recommended, but optional), a dry erase marker (fine point, black Expo2 is preferred) and a stop watch.
2) Flash Card Cutting Instructions: Cut all flash cards the same size as the samples provided. The space at the bottom of the flash cards should not be removed as it allows you to handle the cards easily without having your fingers covering the information when flashing. You may want to laminate the flash cards for easier handling and to preserve for later use with younger children. (Laminating is available at most teacher supply stores.) Do not use clear contact paper as it tends to make the flash cards stick together which interferes with the speed necessary for intensity.
3) Copy Answer Sheets and Speed Drills if not using dry erase method (see below).
   Note: For older children you can move through the first two weeks procedures very rapidly. It may only take 2 days, as long as they understand the concepts.

Week 1—Teaching Multiplication Facts With 0:

Step 1: Begin with the following explanation: “Multiplication is counting groups that are the same size. Zero groups of any number is still zero.” Look at an empty table and say, “if we have no groups or zero groups of plates on the table, how many plates do we have on the table?” Look at the empty living room and say, “If we have zero groups of people in the living-room, how many people are in the living-room?” Now if we said we had zero groups of five instead of plates, how many fives would we have; or, how about zero groups of eights?” etc. Have these conversations with your child throughout the day all during the week, i.e. dinner table (with plates, food and people), with blocks, with videos, etc. Also include groups of numbers in your discussion to drive home the point that zero times any number is zero because we have no or zero groups.

Step 2: Now, take this explanation to written form. On a dry erase board or a blank piece of paper, write, three 0× problems, saying the answer as you write. Example: write 6×0=0, while saying, “Six times zero equals zero.” Then write, 9×0=0 while saying, “Nine times zero equals zero.” Do the same for the third problem. (This is considered 75% instruction-you are doing three to every one the child does.) Refrain from any other verbal explanation. More is not better! Then say, “Your turn”.

Step 3: Write one problem, then give child the marker, or pencil, so they can write the answer for themselves without your input. After the child does this one problem, repeat step 2 with 75% instruction, then child does another problem as described in step 3.

Spend two to three minutes (maximum). You want to leave the child wanting more. Do this two times a day for four days with the described 75% instruction, even if your child seems to know the answers before day five. (Exception: By day three or four, if child is understanding process well, you can move to the following variation.)

Step 3 variation: Parent does one problem (instead of three) then, child does the next problem, (this is considered 50% instruction.). Remember Input is crucial to success. If the child does all the problems that is 100% OUTPUT otherwise known as a “Test”. (Testing has its place, but this is not it) Your child may want to make up their own problems toward the end of the week. This is fine, but only when it is their turn.

All ten 0 times problems should be presented in the format outlined below. You can repeat problems if time allows:

| Day 1: | Day 2: | Day 3: | Day 4: | Day 5: |
|---|---|---|---|---|
| 6 × 0 | 6 × 0 | 6 × 0 | 6 × 0 | 0 × Speed Drill |
| | 0 × 6 | 0 × 6 | 0 × 6 | |
| | | 6 × 0 | 6 × 0 | |
| | | | 0 × 6 | |

Speed Drill Instructions:
1) Ox Speed Drill is introduced on day 5 of the Ox training. Continue using this Speed Drill each day while teaching the 1× facts described under Week 2.
2) Use sheet protectors and dry erase markers for multi day use of Speed Drill or make copies for your families' use only.
3) Have the child write all answers as fast as he can. Tell your child, “Don't try to figure out the answers, just write them from memory. If you don't know the answer, skip that problem and go on to the next one.” Blank answers are your cue that your child needs more input.
4) Mark all problems that are correct with a star or check mark. (An answer key is provided on green paper.) Count correct answers and tell the child to try to beat their score each day. Goal: 3 days of 100%.

5) The Speed Drill builds from week to week As more facts are learned, they appear on the Speed Drill Sheets for review. There is no time limit on a Speed Drill; however, the child should try to beat his own time and accuracy score from day 1 to day 5 of each week. This adds intensity! A stopwatch would be helpful here.

Week 2—Teaching Multiplication Facts with 1:

Step 1: Younger or less experienced children use the “Number Grouping” worksheet. Procedure for use: On the first day, the parent writes three answers for every one answer the child writes. Example: Mom sees . . . _group of 5=_. Mom then circles the 5 dots and writes and says “1 group of 5=5”. She does this for three of the examples on the sheet. (75% instruction) The child does the next one exactly as mom did the previous ones. If the child has no problem with this concept, move on to the written problems as described in step 2 below or continue with this procedure: On the second day of the Number Grouping worksheet, the parent writes two answers for every one answer the child writes. (66% instruction) On the third day, the parent writes one answer for every one answer the child writes. (50% instruction) Repeat worksheet for several days, each time in a different order, i.e. start at the top one day; start at the bottom and work up the next day; one day go from left to right. Do this until the child's response is automatic. Practical application of this procedure around the house as described in 0× explanations would also be very helpful. As soon as the concept is learned move on to step 2.

Step 2: Older children can start with this step. Teach the concept: “One times any number is like saying one group of that number.” Use a dry erase board or a plain piece of paper to input all formats of 1× as you did in 0× explanation. See table below. Be sure to say, “Five times one equals five.” with no more words added. Remember days 1-4 are days to input 1× and reinforce knowledge with the 0× Speed Drill

| Day 1: | Day 2: | Day 3: | Day 4: | Day 5: |
|---|---|---|---|---|
| 5 × 1 | 5 × 1 | 5 × 1 | 5 × 1 | 1 × Speed Drill |
| | 1 × 5 | 1 × 5 | 1 × 5 | |
| | | 5 × 1 | 5 × 1 | |
| | | | 1 × 5 | |
| 0 × Speed | 0 × Speed | 0 × Speed | 0 × Speed | |
| Drill | Drill | Drill | Drill | |

Now you are ready to start the complete multi-sensory aspect of Math N' More Math Facts In a Flash Multiplication Module. The next few weeks will be a different format than the first 2 weeks.

Overview of Daily Procedure:

| Activity | Duration |
|---|---|
| Listen only to track with math facts | 3 minutes |
| Listen to same track and fill in answers on corresponding | 3 minutes |
| yellow Answer | |
| Sheet (match symbol on track to symbol on Answer Sheet) | |
| Math Facts Flash Card session with mom (match symbol) | 1 minute |
| Math Facts Flash Card session with mom (same cards as | 1 minute |
| above) | |
| Speed Drill (match symbol on track with symbol on Speed | 1 minute |
| Drill) | (approx.) |

Multiplication Track Reference Table

| | | | | | | | | | |
|---|---|---|---|---|---|---|---|---|---|
| [symbol] | Track 1 | 2 × 2 = 4 | 4 × 3 − 12 | 3 × 4 = 12 | 6 × 5 = 30 | 5 × 6 = 30 | 7 × 2 = 14 | 2 × 7 = 14 | |
| ♥ | Track 2 | 3 × 3 = 9 | 4 × 2 = 8 | 2 × 4 = 8 | 7 × 6 = 42 | 6 × 7 = 42 | 8 × 3 = 24 | 3 × 8 = 24 | |
| ▪ | Track 3 | 4 × 4 = 16 | 3 × 2 = 6 | 2 × 3 = 6 | 5 × 4 = 20 | 4 × 5 = 20 | 9 × 6 = 54 | 6 × 9 = 54 | |
| [symbol] | Track 4 | 5 × 5 = 25 | 7 × 3 = 21 | 3 × 7 = 21 | 8 × 4 = 32 | 4 × 8 = 32 | 9 × 2 = 18 | 2 × 9 = 18 | |
| ▴ | Track 5 | 6 × 6 = 36 | 5 × 2 = 10 | 2 × 5 = 10 | 6 × 3 = 18 | 3 × 6 = 18 | 9 × 7 = 63 | 7 × 9 = 63 | |
| [symbol] | Track 6 | 7 × 7 = 49 | 5 × 3 = 15 | 3 × 5 = 15 | 6 × 4 = 24 | 4 × 6 = 24 | 9 × 8 = 72 | 8 × 9 = 72 | |
| ♦ | Track 7 | 8 × 8 = 64 | 8 × 7 = 56 | 7 × 8 = 56 | 9 × 3 = 27 | 3 × 9 = 27 | 6 × 2 = 12 | 2 × 6 = 12 | |
| ¶ | Track 8 | 9 × 9 = 81 | 7 × 4 = 28 | 4 × 7 = 28 | 8 × 5 = 40 | 5 × 8 = 40 | 8 × 2 = 16 | 2 × 8 = 16 | |
| ▾ | Track 9 | 7 × 5 = 35 | 5 × 7 = 35 | 9 × 436 | 4 × 9 = 36 | 9 × 5 = 45 | 5 × 9 = 45 | 8 × 6 = 48 | 6 × 8 = 48 |

Math Facts 2× and up:

Each day for one week, your child will listen to the same track of specific facts. He will also see flashcards with these same facts and complete Speed Drills reviewing previously learned facts.

Track 1: (This is the Template to be Used on all Tracks)

Have your child listen to the 3 minute track, twice a day (preferably one to four hours apart). One time, the child just listens. The next time, have him drill in the answers on the yellow Answer Sheet with the corresponding symbol for the current track. The child listens to the CD, finds the problem on the first row and writes the answer. Each row should be completed before moving to the next row. The facts on the answer sheet are in a different order from the CD. This adds intensity because they have to listen carefully and hunt for the problem before writing the answer.

Neurodevelopmental Hint: To make the long-term memory of facts more effective, listen to the CD in one ear only. Choose the ear that matches the child's dominant hand, (the one they write with). During flash sessions, patch the eye opposite the dominant hand. i.e. A right handed child would have their left eye patched so the information was being stored efficiently by the right eye.

Flash Card Input Sessions: Follow these directions two times a day. (If possible separate each session by at least 30 minutes.)
1) Separate the 7 flash cards with the same symbol as the track you are working on.
2) Flash these cards, using the technique described below, as fast as the child can read them (make sure the answer is showing—Remember—Input). The speed of the flash helps with intensity and gives time for more input.
3) Mix the order of flash cards and repeat flash with child reading as fast as before.
4) Mix the order of flash cards again. This time cover the answer, have the child read the problem and then give the answer from memory. If he/she hesitates, just show the answer and have them read it quickly again. This flash session should take 1 to ½ minutes (maximum). Remember, more is not better, but frequency and intensity, over time, makes all the difference.
5) Optional Review: One time a week, flash all previously learned facts with 66% input.
6) Procedure: Child reads two cards with answer showing, and then the third card the answer is covered while they read and answer from memory. Change the order of cards for each weeks review.

Flash Card Technique:
1) Hold the flash cards facing you and then rotate them until they are upside down.
2) Fan cards so that you can easily and quickly grab each one.
3) While holding the fanned flash cards in your left hand, place the fingers of your right hand in the blank space of the flash card closest to you with your thumb on the back of the card. (Reverse hands if you are left handed.) Then, flip the card into a full vertical position facing the child. Have the child read the card as fast as possible, then place the card face down on the table in front of you and immediately flip up the next flash card.

Suggested Daily Schedule: Use Daily Tracking Sheet (make copies of the one provided) to help keep track of all steps of the Math N' More Math Facts In A Flash Multiplication system each day.
1) Early morning—Listen only to specific track for that week.
2) 1^{st} flash card session with 7 facts corresponding to track on CD
3) Mid to late morning—2^{nd} flash card session (same facts)
4) After lunch—While listening to same track as in the morning, record answers on corresponding yellow Answer Sheet. (There should be at least 10 to 15 minutes between listening and flash sessions.)
5) Speed Drill can be done any time of day because it is a review of previous weeks. Be sure to use Speed Drill with the same symbol as the CD track for that week.
   After the child has done all the tracks, have him redo any tracks containing facts where recall is not automatic.

Math-Facts-In-A-Flash Daily Tracking Sheet

[image]

[image]

Number Grouping Worksheet—Make one circle around all the dots, then fill in the blanks.

| | | |
|---|---|---|
| 1 ----- 5 | -- | --------- |
| group of 5 = | group of 2 = | group of 9 = |
| --- | ------- | ---- |
| group of 3 = | group of 7 = | group of 4 = |
| -------- | ------ | |
| group of 8 = | group of 6 = | group of 0 = |
| - | ----- | -- |
| group of 1 = | group of 5 = | group of 2 = |
| --- | ------ | ----- |
| group of 3 = | group of 6 = | group of 5 = |
| --------- | - | -- |
| group of 9 = | group of 1 = | group of 2 = |
| ------ | ---- | -------- |
| group of 7 = | group of 4 = | group of 8 = |
| - | --- | ----- |
| group of 1 = | group of 3 = | group of 5 = |
| ------ | ----- | -- |
| group of 6 = | group of 5 = | group of 2 = |
| ---- | -------- | - |
| group of 4 = | group of 8 = | group of 1 = _{—} |

Math N' More Math Facts In A Flash Division Module

Math N' More Math Facts In A Flash Division Module (where math fact are retrieved min a flash) has a very unique format. It includes intense visual, auditory and tactile input to the brain so math facts are learned quickly and retained long term. Input (instruction), with frequency (how often), intensity (how strong) and controlled duration (how much time per session and over enough days), is the key to success. Please read and follow these instructions carefully. Division by 1, and all numbers divided into themselves will be taught first and in a slightly different format from the other facts.

Getting Started:

Read all instructions (pages 1-4) before starting and review the contents of this package.

Detailed Instructions
CD with 2 min. tracks of specific math facts
Discovery Game Answer Sheets
Flash Cards
Speed Drills
Daily Tracking Sheet
Sheet Protector
1. Be sure you have the following supplies: a 3-ring notebook with pockets to keep your math facts system organized, a CD player, headphones (recommended, but not required), a dry erase marker (fine point, black Expo2 is preferred) and a stop watch or timer.
2. Flash Card Cutting Instructions: Cut all flash cards the same size as the samples provided. The space on the left hand side of the flash cards should not be removed as it allows you to handle the cards easily without your fingers covering the information when flashing. You may want to laminate the flash cards for easier handling and to preserve for later use with younger children. (Laminating is available at most teacher supply stores.) Do not use clear contact paper as it tends to make the flash cards stick together which interferes with the speed necessary for intense flash sessions.
3. Using the dry erase method (described below) is recommended. If you do not use this method you will need to make 5 copies each of the Answer Sheets and Speed Drills and 3 copies of the Daily Tracking Sheet.
4. Note: For older children you can move through the first two weeks procedures very rapidly. It may only take 1-2 days for them to understand or review the concepts.

Week 1—Teaching Division Facts with 1: Note: Older children may not need step 1 and 2, in which case you should proceed to step 3.

Step 1: Begin with the following explanation: “Division is putting things in groups that are the same size. One group of any number is still that same number.” Look at a table with 5 plates on it and say, “If we put the plates on the table in one group, how many plates do we have in the groups” Look at the living room with 5 people in it and say, “if we have 5 people in the living-room and put them all in one group, how many people are in the group?” Have these conversations with your child throughout the day all during the week, i.e. dinner table (with plates, food, people), with blocks, with videos, etc. The goal is to drive home the point that one group of any number is that same number.

Step 2: Younger or less experienced children use the green “Number Grouping” worksheet for Week 1 provided at the end of the instruction pages. Procedure for use: On the first day, the parent writes three answers for every one answer the child writes on the Number Grouping worksheet. Example: Mom sees . . . 5 divided into 1 group=_. Mom then circles the 5 dots and writes and says “5 divided into 1 group=5”. She does this for three of the examples on the sheet. (75% instruction) The child does the next one exactly as mom did the three previous ones. If the child has no problem with this concept, move on to Step 3.

If the child is having trouble understanding this concept, continue with this Number Grouping worksheet (as described here) for approximately one week before proceeding to step 3 as follows: On the second day of the Number Grouping worksheet, the parent writes two answers for every one answer the child writes. (66% instruction) On the third day, the parent writes one answer for every one answer the child writes. (50% instruction) Repeat this worksheet for several days, each time in a different order, i.e. start at the top one day; start at the bottom and work up the next day; one day go from left to right. Do this until the child's response is automatic. Then continue to step 3.

Step 2 Daily Activity Chart

| Day 1: | Day 2: | Day 3: | Day 4: | Day 5: |
|---|---|---|---|---|
| Number | Number | Number | Number | Number |
| Grouping | Grouping | Grouping | Grouping | Grouping |
| Worksheet for | Worksheet for | Worksheet for | Worksheet for | Worksheet for |
| Week 1 | Week 1 | Week 1 | Week 1 | Week 1 |
| Mom does 3, | Mom does 2, | Mom does 1, | Mom does 1, | Mom does 1, |
| Child does 1 | Child does 1 | Child does 1 | Child does 1 | Child does 1 |

Step 3: Older children may start with this step.

Teach the concept: “Any number divided by one is the same as saying one group of that number.” If you have done step 1 and 2 above, you have already taught this concept so proceed to Part 1 and 2. This step has two parts:

Part 1: Reading division problems in their different forms.
Part 2: Writing division problems in their different forms.
   Part 1—For children of all ability levels, an input (instructional) session is needed at this point to get the child used to seeing division problems in their various written forms.

Procedure: Day 1, Mom reads each problem from the “Reading Division Problems” worksheet, pointing to each part of the problem as the child follows along. Saying the answer is not necessary, this drill is only for teaching how division problems are read. Days 2 through 4, follow directions provided in chart below. Then use the dry erase board or paper to write several horizontal (÷) division problems as shown below under Day 1. Practice all ÷1 problems from 1-10. This should take approximately 3 to 5 minutes, maximum.

Note: During this week, we are showing all forms of division as we teach the facts so when children get to fractions they will understand that the line between the numbers means divide.

Part 2

A new form of writing the problems will be introduced each day. Introduce only one new form a day. See chart below. As you write the problem, be sure to say, “Five divided by one equals five.” “Seven divided by one equals seven.” “Ten divided by one equals ten.” etc. with no more words added. Remember days 1-4 are days to mainly input for dividing by 1, i.e. Mom does one or two problems on dry erase board or paper before the child writes his or her first answer, then it is mom's turn again.

Summary: Each day mom and child are taking turns reading the “Reading Division Problems” worksheet before doing the written exercise described below in daily activity chart. Your pages will look like the chart, using different numbers divided by one.

Step 3 Daily Activity Chart

| Day 1: | Day 2: | Day 3: | Day 4: | Day 5: |
|---|---|---|---|---|
| Reading ÷ | Reading ÷ | Reading ÷ | Reading ÷ | 8 ÷ 1= |
| Problems | Problems | Problems | Problems | |
| Mom reads all | Mom reads 2, | Mom reads 1 | Mom reads 1 | |
| problem | child reads 1 | problem, child | problem, child | |
| | problem | reads 1 problem | reads 1 problem | |
| 5 ÷ 1 = | 6 ÷ 1 = | 4 ÷ 1 = | 7 ÷ 1 = | 1/3 |
| 7 ÷ 1 = | 1/8 | 1/9 | 1/2 | 6 |
| | | | | 1 |
| 10 ÷ 1 = | 7 | 3 | 5 | ÷1 Speed Drill |
| | 1 | 1 | 1 | |

Week 2—Dividing A Number Into Itself: Note: Older children may need to spend only one day on this activity.

Teach the child that the divisor means how many groups that a number is going to be divided into. Practical example: “If we have 6 plates and we want to divide them into six groups, how many plates would be in each group?” Use different items to illustrate this point i.e. nuts, blocks, small counter, etc.

After the understanding is accomplished by this hands-on example, you will want to demonstrate the math sentence that represents the concept you have just taught.*

The Week 2 activity chart shows what each day's written problems will look like. Be sure to vary the number from 1-20 in each problem and say it as you write it. We recommend continuing the “Reading Division Problems” worksheet for one more week as described below.

Week 2—Daily Activity Chart

| Day 1: | Day 2: | Day 3: | Day 4: | Day 5: |
|---|---|---|---|---|
| Number Grouping | Number Grouping | Number Grouping | Number Grouping | Number Grouping |
| Worksheet for Week 2 | Worksheet for Week 2 | Worksheet for Week 2 | Worksheet for Week 2 | Worksheet for Week 2 |
| Reading ÷ Problems | Reading ÷ Problems | Reading ÷ Problems | Reading ÷ Problems | |
| Mom reads 1 | Mom reads 1 | Mom reads 1 | Mom reads 1 | |
| problem, child reads | problem, child reads | problem, child reads | problem, child reads | |
| 1 problem | 1 problem | 1 problem | 1 problem | |
| 5 ÷ 5 = | 1 ÷ 1 = | 3 ÷ 3 = | 6 ÷ 6 = | |
| 8 ÷ 8 = | 17/17 = | 9/9 = | 15/15 | |
| 2 ÷ 2 = | 8 | 4 | 3 | |
| | 8 | 4 | 3 | |
| ÷1 Speed Drill | ÷1 Speed Drill | ÷1 Speed Drill | ÷1 Speed Drill | ÷1 Speed Drill |

Do the Number Grouping Worksheet for Week 2 for as many days as needed for your child's understanding.

Now you are ready to start the complete multi-sensory aspect of Math N' More Math Facts In A Flash Division Module. The next 13 weeks will be a different format than the first two. Small symbols are on all pages and all flash cards. Be sure to match the symbols on the CD track, Answer Sheet, Drill Sheet and Flash Cards for that week.

Overview of Daily Procedure:

| Activity | Duration |
|---|---|
| Listen only to track with math facts | 2 minutes |
| Math facts flash card session with mom | 1 minute |
| (Always match symbols) | |
| Listen to same track and fill in answers on | 2 minutes |
| corresponding yellow Answer Sheet (Always | |
| match symbol on track to symbol on Answer Sheet) | |
| Math flash card session with mom (Always | 1 minute |
| match symbols) | |
| Speed Drill (Always match symbol on track | 1 minute (approx.) |
| with symbol on Speed Drill) | |

Division Track Reference Table

| | | | | | | |
|---|---|---|---|---|---|---|
| [symbol] | Track 1 | 8 ÷ 8 = 1 | 10 ÷ 5 = 2 | 10 ÷ 2 = 5 | 12 ÷ 3 = 4 | 12 ÷ 4 = 3 |
| ♥ | Track 2 | 6 ÷ 2 = 3 | 15 ÷ 3 = 5 | 15 ÷ 5 = 3 | 14 ÷ 7 = 2 | 14 ÷ 2 = 7 |
| ▪ | Track 3 | 6 ÷ 3 = 2 | 16 ÷ 8 = 2 | 16 ÷ 2 = 8 | 21 ÷ 7 = 3 | 21 ÷ 3 = 7 |
| [symbol] | Track 4 | 8 ÷ 2 = 4 | 18 ÷ 3 = 6 | 18 ÷ 6 = 3 | 20 ÷ 4 = 5 | 20 ÷ 5 = 4 |
| ▴ | Track 5 | 8 ÷ 4 = 2 | 12 ÷ 6 = 2 | 12 ÷ 2 = 6 | 28 ÷ 7 = 4 | 28 ÷ 4 = 7 |
| [symbol] | Track 6 | 4 ÷ 2 = 2 | 24 ÷ 3 = 8 | 24 ÷ 8 = 3 | 30 ÷ 5 = 6 | 30 ÷ 6 = 5 |
| ♦ | Track 7 | 9 ÷ 3 = 3 | 24 ÷ 4 = 6 | 24 ÷ 6 = 4 | 18 ÷ 2 = 9 | 18 ÷ 9 = 2 |
| ¶ | Track 8 | 16 ÷ 4 = 4 | 27 ÷ 3 = 9 | 27 ÷ 9 = 3 | 35 ÷ 5 = 7 | 35 ÷ 7 = 5 |
| ▾ | Track 9 | 25 ÷ 5 = 5 | 32 ÷ 4 = 8 | 32 ÷ 8 = 4 | 54 ÷ 6 = 9 | 54 ÷ 9 = 6 |
| % | Track | 36 ÷ 6 = 6 | 63 ÷ 7 = 9 | 63 ÷ 9 = 7 | 40 ÷ 8 = 5 | 40 ÷ 5 = 8 |
| | 10 | | | | | |
| [symbol] | Track | 49 ÷ 7 = 7 | 36 ÷ 9 = 4 | 36 ÷ 4 = 9 | 48 ÷ 6 = 8 | 48 ÷ 8 = 6 |
| | 11 | | | | | |
| √ | Track | 64 ÷ 8 = 8 | 45 ÷ 9 = 5 | 45 ÷ 5 = 9 | 56 ÷ 7 = 8 | 56 ÷ 8 = 7 |
| | 12 | | | | | |
| [symbol] | Track | 81 ÷ 9 = 9 | 72 ÷ 9 = 8 | 72 ÷ 8 = 9 | 42 ÷ 6 = 7 | 42 ÷ 7 = 6 |
| | 13 | | | | | |

Math Facts÷2 and up:

Each day for one week, your child will listen to the same track of 5 specific division facts. He will also see flash cards with these same facts and complete Speed Drills reviewing previously learned facts.

Note: Speed Drills are always 1 week behind what is currently being learned through the Flash Facts System.

INSTRUCTION: (This model applies to all tracks)_Track 1: Have your child listen to the 2-minute track, twice a day (preferably one to two hours apart). One time, the child just listens. The next time, have him fill in the answers on the yellow Answer Sheet with the corresponding symbol for the current track. The child listens to the CD, finds the problem on the first row and writes the answer he hears. Each row should be completed before moving to the next row. The facts on the answer sheet are in a different order from the CD. This adds intensity because the child must listen carefully and hunt for the problem before writing the answer.

Neurodevelopmental Hint: To make the long-term memory of facts more effective, the child should listen to the CD in one ear only through the headphones. Choose the ear that matches the child's dominant hand, (the one they write with). During flash sessions, patch the eye opposite the dominant hand. i.e. A right handed child should have their left eye patched so the information will be stored efficiently by the right eye. For more information on dominance, see articles on our web site at www.littlegiantseps.com or email us at lgssupport@comcast.com.

Flash Card Input Sessions: Follow these directions two times a day. (If possible separate each flash session by at least 30 minutes.)
(1) Separate the 5 flash cards with the symbol matching the track you are currently working on.
(2) Flash these cards using the technique described below, as fast as the child can read them (make sure the answer is showing—Remember—Input). Use a fast speed of the flash cards as it helps with intensity and gives time for more input.
(3) Mix the order of flash cards and repeat flash with child reading as fast as before.
(4) Mix the order of flash cards again. This time cover the answer, have the child read the problem and give the answer from memory. If he/she hesitates, just show the answer and have the child read it quickly again. This flash session should take 1 to 1½ minutes (maximum). Remember, more is not better, but frequency and intensity, over time, makes all the difference because of INPUT!
(5) Optional Review: One time a week, flash all previously learned facts with 66% input.
(6) Procedure: Child reads two cards with answer showing, on the third card the answer is covered while he or she reads the problem and answers from memory. Repeat using 2 input cards and 1 output card through all review facts. Change the order of cards for each week's review.

Flash Card Technique:
(1) Hold the flash cards facing you and then rotate them until they are upside down.
(2) Fan cards so that you can easily and quickly grab each one.
(3) While holding the fanned flash cards in your left hand, place the fingers of your right hand in the blank space of the flash card closest to you with your thumb pointing down and on the back of the card. (Reverse hands if you are left handed.) Then, flip the card into a full horizontal position facing the child. Have the child read the card as fast as possible, then place the card face down on the table in front of you and immediately flip up the next flash card. Child should be viewing only one problem at a time.

Suggested Daily Schedule: Use Daily Tracking Sheet (make copies of the one provided) to help keep track of all steps of the Math N' More Math Facts In A Flash Division system each day.
(1) Early morning—Listen only to a specific track for that week.
(2) 1^{st} flash card session with 5 facts corresponding to track on CD
(3) Mid to late morning—While listening to same track as in the morning, record answers on corresponding yellow Answer Sheet. (There should be at least 10 to 15 minutes between listening and flash sessions.)
(4) After lunch—2^{nd} flash card session (same facts)
(5) Speed Drill can be done any time of day because it is a review of facts from previous weeks. Be sure to use Speed Drill with the same symbol as the CD track for that week.

After the child has done all the tracks, have him redo any tracks containing facts where recall is not automatic. To determine which tracks need to be redone, watch him do the review speed drill and make note of all the problems in which he hesitates before answering.

Math N' More Math Facts In A Flash—Daily Tracking Sheet

[image]

[image]

Number Grouping Worksheet Week 1

Talk about how many groups they made and how many are in each group. Make one circle around all the dots, then fill in the blanks. The first one is done for you.

| | | |
|---|---|---|
| ----- | -- | --------- |
| 5 ÷ into 1 group = 5 | 2 ÷ into group = | 9 ÷ into group = |
| in each group | in each group | in each group |
| --- | ------- | ---- |
| 3 ÷ into group = | 7 ÷ into group = | 4 ÷ into group = |
| -------- | ------ | |
| 8 ÷ into group = | 6 ÷ into group = | 0 ÷ into group = |
| - | ----- | -- |
| 1 ÷ into group = | 5 ÷ into group = | 2 ÷ into group = |
| --- | ------ | ----- |
| 3 ÷ into group = | 6 ÷ into group = | 5 ÷ into group = |
| --------- | - | -- |
| 9 ÷ into group = | 1 ÷ into group = | 2 ÷ into group = |
| ------ | ---- | -------- |
| 6 ÷ into group = | 4 ÷ into group = | 8 ÷ into group = |
| - | --- | ----- |
| 1 ÷ into group = | 3 ÷ into group = | 5 ÷ into group = |
| ------ | -------- | ---- |
| 6 ÷ into group = | 8 ÷ into group = | 4 ÷ into group = _{—} |

Number Grouping Worksheet Week 2

Talk about how many groups they made and how many are in each group. Make one circle around each dot, then fill in the blanks. The first one is done for you.

| | | |
|---|---|---|
| ----- | -------- | --------- |
| 5 ÷ into 5 groups = 1 | 8 ÷ into groups = | 9 ÷ into groups = |
| in each group | in each group | in each group |
| - | --- | ----- |
| 1 ÷ into groups = | 3 ÷ into groups = | 5 ÷ into groups = |
| ------ | ---- | -------- |
| 6 ÷ into groups = | 4 ÷ into groups = | 8 ÷ into groups = |
| --------- | - | -- |
| 9 ÷ into groups = | 1 ÷ into groups = | 2 ÷ into groups = |
| --- | ------ | ----- |
| 3 ÷ into groups = | 6 ÷ into groups = | 5 ÷ into groups = |
| - | ----- | -- |
| 1 ÷ into groups = | 5 ÷ into groups = | 2 ÷ into groups = |
| -------- | ------ | |
| 8 ÷ into groups = | 6 ÷ into groups = | 0 ÷ into groups = |
| --- | ------- | ---- |
| 3 ÷ into groups = | 7 ÷ into groups = | 4 ÷ into groups = |
| --------- | -- | ----- |
| 9 ÷ into groups = | 2 ÷ into groups = | 5 ÷ into groups = _{—} |

BACKGROUND FOR INVENTION—The Neurodevelopmental Approach was originally developed in the mid 1950s though the work of Glen Doman, Educator. and Dr. Carl Delacato, Ed. D. They were best known for their rehabilitation technique based on normal neurological development, taking the individual through the developmental process using reflex patterns encoded in the central nervous system: Doman-Delacato Treatment Procedures. They discovered, by working with children who were brain injured, they could bring remedial aide and restore or improve function in cognitive processing by conducting therapeutic activities that stimulate the brain, which would allow these children to improve their ability to learn, thus making it possible for them to work to their potential levels. Many of these children were able to create a better and meaningful life despite their disabilities.

American educator, Glen Doman, had developed a method to educate children with cerebral palsy, a type of brain damage that can produce children with mental and or physical limitations for the rest of their life. His method succeeded in helping brain damaged children to such an extent that they were able to read and write and attend school like normal children. Mr. Doman founded the Rehabilitation Center at Philadelphia in 1955. Their name was changed to the Institutes For Achievement Of Human Potential in 1962 which is still active today worldwide.

The success of Doman's method made him think and ask: “Why not try this on normal children with healthy brains?” He tried and discovered that there is no end to how early and how rapidly children can learn to read, calculate and acquire encyclopedic knowledge. Through his methods, children are able to recognize and understand hundreds of words in several languages even before they can speak or walk! By the time they are ready to enter primary school, they can attain the reading, writing and general knowledge normally achieved after six years of schooling. And all this is done through very simple methods that every mother can practice at home with her own children.

In his paper “Ontogeny of Reading Problems” presented to Claremont Reading Conference in 1963, Dr Carl Delacato, Ed.D reasoned that “the process by which one attains the ability to read—the ability to learn to express oneself starts at birth. If the child is not afforded the opportunity to develop total neurological organization, the child cannot become totally “human”, and as a result cannot communicate at the level at which the child might have been able to, had neurological organization been completed.”

In 1970, Carl Delacato proposed a new revolutionary concept together with a new curative therapy, outlined in his book, “A New Start for the Child with Reading Problems”.

The 1963 paper, and his book in 1970, both stem from original research presented to the Institute of Physical Medical and Rehabilitation, New York in 1953, by Delacato, Doman and Doman, entitled “Behavior, Learning and Mobility, cause and effect of Rehabilitation”. In this paper the principles of Sensory Integration Therapy are proposed.

To put this theory into its simplest terms, systems of reading and language difficulty, show up where there is conflict between one side of the brain and the other to gain language dominance. In the human brain the language area is usually located in either, the left, or right side of the brain. Likewise, man is usually left-handed or right-handed.

Normally, dominance in the brain begins as soon as baby learns to speak. Total dominance achieved around 7 to 8 years of age. Theoretically, missing of any stage of development between crawling, creeping, walking, seeing, talking and writing creates problems in reading.

Accordingly, for the poor reader, the method suggests re-imprinting the early stages of brain dominance, by repeating in the brain, the early steps in creeping and crawling, (cross patterning activities) and other physical exercises that develop the receptivity of the language area of the brain.

### REFERENCES

1. “A New Start For The Child With Reading Problems” Carl Delacato, Ed. D. 1970
2. “How To Teach Your Baby To Be Physically Superb” Glenn Doman, Douglas Doman & Bruce Hagy. 1988
3. “Brain-Injured Children” Evan W. Thomas, M.D. A chapter by Edward B. LeWinn, M.D. F.A.C.P. 1969 (Special Reference To Doman-Delacato Methods of Treatment)
4. NACD website—www.nacd.org

What is claimed is:

1. Math 'N More Educational & Neurodevelopmental Curriculum Series incorporates multiple levels and products in multiple media types based on stimulating cognitive processing, information processing for the purpose of activating learning. The Math N' More Early Learning Series works from concepts which promote learning by engaging the child in a number of activities dealing with cognitive processing issues through exercises with number correspondence, word recognition, pattern recognition, counting, identification of various objects, shapes, numbers and words, discrimination of many words, numbers, more or less and categories, as well as tracing, directional writing, addition and subtraction finger math, listening to CDs, math facts for addition, subtraction, multiplication, and division, speed drills in math facts, and flash card activities, as well as incorporating multi-sensory neurodevelopmental activities such as: cross patterning, auditory digit spans, touch sequences, object sequences, listening to therapeutic sound tracks and or books on tape, concentration games, visual digit spans, visual touch and object sequences, tactile, dexterity, fine motor, neuro-muscular strengthening.

2. The concept of Math N' More is unique in that it combines knowledge of how the brain learns with a step by step approach to the activities that stimulate the brain via multi-sensory actions that teach math and reading and writing readiness skills in addition to providing brain stimulating activities for the purpose of strengthening and/or developing neuro-pathways that facilitate more efficient and effective receiving, retrieval, storage, and utilization of information known as knowledge.

3. The brain has great plasticity and research has proven that additional specific stimulation of the brain, in areas of the brain where a child or adult has had injury or insufficient neuro-stimulation as infants, can create a branching in the dendrites, and thus change the status of the neuro-pathways. With stronger neuro-pathways established, better connectivity between the brain and body are accomplished which increases the ability in the cerebral areas for better brain organization, auditory and visual processing, fine and gross motor skills, and language skills which will allow the individual to acquire information easier and retain it as knowledge for a longer period of time with more rapid recall.

4. The Method of claim 1 further comprising the steps of: When presenting new information and educating students giving more sensory input than extracting output is essential for effective learning to take place.

5. The Method of claim 1 further comprising the steps of: Telling, showing, repeating and modeling words, numbers, and actions is required input to be given in short sessions of high intensity with repetition (especially for children with learning difficulties where more input is required in a greater degree) that provides a physiological response to construct synaptic connections to build basic structures that represent knowledge. FREQUENCY, INTENSITY and DURATION are the keys to learning and is vital when teaching math with the Math N' More Series.

6. The Method of claim 1 further comprising the steps of: The Math N' More Early Learning Series program is set up to have a child complete 1-3 pages a day. The Math N' More Math Facts In A Flash is to be done (and is most effective) between 7 to 9 minutes a day.

7. The Method of claim 1 further comprising the steps of: If a specific type of activity is too difficult for the individual because of a physical limitation or because of where he is developmentally, the option to alter it slightly so the individual can accomplish it, or skip that activity entirely for a time. If activities are skipped, go back every week and try again so that when the individual is ready you can fill in that missing piece and begin to work the program to its fullest potential.

8. The Method of claim 1 further comprising the steps of: It is advantageous to complete all the activities because they build on each other and help develop the foundational skills necessary for improved learning.

9. The Method of claim 1 further comprising the steps of: Every three pages in the Math N' More Early Learning Series contains enough frequency, intensity and activities with short duration to produce good connections in the brain.

10. The Method of claim 1 further comprising the steps of: The order of completing the activities is very flexible. The order varies from page to page to help add variety.
